(19) United States
(12) Patent Application Publication
(10) Pub. No.: US 2014/0194473 A1
(43) Pub. Date: Jul. 10, 2014

(54) IMIDAZOLE FUNGICIDES

(71) Applicant: E I Du Pont De Nemours And Company, Wilmington, DE (US)

(72) Inventor: THOMAS FRANCIS PAHUTSKI, JR., Elkton, MD (US)

(73) Assignee: E I Du Pont De Nemours And Company, Wilmington, DE (US)

(21) Appl. No.: 14/101,681

(22) Filed: Dec. 10, 2013

Related U.S. Application Data
(60) Provisional application No. 61/750,863, filed on Jan. 10, 2013.

(51) Int. Cl. A01N 43/50

(52) U.S. Cl. CPC A01N 43/50
USPC 514/341; 548/326.5; 514/398; 514/397; 548/315.1; 546/274.1

(57) ABSTRACT

Disclosed are compounds of Formula 1, including all stereoisomers, N-oxides, and salts thereof,

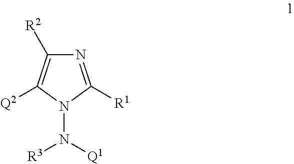

wherein
Q¹, Q², R¹, R² and R³ are as defined in the disclosure.
   Also disclosed are compositions containing the compounds of Formula 1 and methods for controlling plant disease caused by a fungal pathogen comprising applying an effective amount of a compound or a composition of the invention.

### FIELD OF THE INVENTION

This invention relates to certain imidazoles, their N-oxides, salts and compositions, and methods of their use as fungicides.

### BACKGROUND OF THE INVENTION

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new compounds which are more effective, less costly, less toxic, environmentally safer or have different sites of action.

PCT Patent Publications WO 2009/137538, WO 2009/137651, WO 2011/056463 and WO 2012/044650 disclose imidazole fungicides. Ganguly et al., Journal of Young Pharmacists 2009, 1(3), 251-258 disclose imidazole derivatives and their use as anti-HIV agents.

### SUMMARY OF THE INVENTION

This invention is directed to compounds of Formula 1 (including all stereoisomers), N-oxides, and salts thereof, agricultural compositions containing them and their use as fungicides:

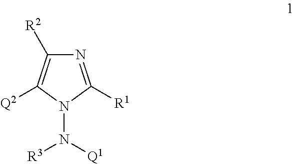

wherein
Q¹ is a phenyl, thienyl, pyridinyl, pyridazinyl, pyrazinyl or pyrimidinyl ring, each ring optionally substituted with up to 5 substituents independently selected from R^{4a};
Q² is a phenyl, thienyl, pyridinyl, pyridazinyl, pyrazinyl or pyrimidinyl ring, each ring optionally substituted with up to 5 substituents independently selected from R^{4b};
R¹ is H, halogen, cyano, nitro, C₁-C₃ alkyl, C₂-C₃ alkenyl, C₂-C₃ alkynyl, C₁-C₃ haloalkyl, C₂-C₃ haloalkenyl, cyclopropyl, C₁-C₃ hydroxyalkyl, C₂-C₃ cyanoalkyl, C₂-C₃ alkoxyalkyl, C₁-C₃ alkoxy, C₁-C₃ haloalkoxy, C₁-C₃ alkylthio or C₁-C₃ haloalkylthio;
R² is H, halogen, cyano, nitro, C₁-C₃ alkyl, C₂-C₃ alkenyl, C₂-C₃ alkynyl, C₁-C₃ haloalkyl, C₂-C₃ haloalkenyl, cyclopropyl, C₁-C₃ hydroxyalkyl, C₂-C₃ cyanoalkyl, C₂-C₃ alkoxyalkyl, C₁-C₃ alkoxy, C₁-C₃ haloalkoxy, C₁-C₃ alkylthio or C₁-C₃ haloalkylthio;
R³ is H, hydroxy, —CH(═O), C₁-C₆ alkyl, C₂-C₆ alkenyl, C₂-C₆ alkynyl, C₁-C₆ haloalkyl, C₃-C₆ cycloalkyl, C₃-C₆ halocycloalkyl, C₄-C₆ alkylcycloalkyl, C₄-C₆ cycloalkylalkyl, C₂-C₆ alkoxyalkyl, C₂-C₆ cyanoalkyl, C₂-C₆ alkylthioalkyl, C₂-C₆ alkylsulfinylalkyl, C₂-C₆ alkylsulfonylalkyl, C₂-C₆ alkylaminoalkyl, C₃-C₆ dialkylaminoalkyl, C₁-C₆ alkoxy, C₁-C₆ haloalkoxy, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₂-C₆ alkylcarbonyl, C₂-C₆ alkoxycarbonyl, C₂-C₆ (alkylthio)carbonyl, C₂-C₆ alkyl(thiocarbonyl), C₂-C₆ alkoxy(thiocarbonyl) or —S(═O)₂OM;
each R^{4a} and R^{4b} is independently halogen, cyano, hydroxy, nitro, C₁-C₃ alkyl, C₂-C₃ alkenyl, C₂-C₃ alkynyl, C₁-C₃ haloalkyl, C₂-C₃ haloalkenyl, cyclopropyl, C₂-C₃ cyanoalkyl, C₁-C₃ alkoxy, C₁-C₃ haloalkoxy, C₁-C₃ alkylthio, C₁-C₃ haloalkylthio, C₁-C₃ alkylsulfinyl, C₁-C₃ haloalkylsulfinyl, C₁-C₃ alkylsulfonyl, C₁-C₃ haloalkylsulfonyl, C₂-C₃ alkylcarbonyl, C₁-C₃ alkylamino, C₂-C₃ dialkylamino, C₂-C₃ alkylcarbonylamino, —SC≡N, —C(≡W)NH₂ or -T-U—V;
each T is independently O, S(═O)ₙ, NR⁵ or a direct bond;
each U is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are independently selected from C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each V is independently cyano, N(R^{6a})(R^{6b}), OR⁷ or S(═O)—R⁷;
each R⁵ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{6a} and R^{6b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{6a} and R^{6b} are taken together with the nitrogen atom to which they are attached to form a 3- to 6-membered heterocyclic ring, the ring optionally substituted with up to 5 substituents independently selected from R⁸;
each R⁷ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R⁸ is independently halogen, C₁-C₆ alkyl, C₁-C₆ haloalkyl or C₁-C₆ alkoxy;
each W is independently O or S;
M is K, Na or Li;
each n is independently 0, 1 or 2;
   provided that:
(a) when R¹ is H, R² is other than H;
(b) the compound is other than N-(2,5-dichlorophenyl)-4-methyl-5-phenyl-1H-imidazol-1-amine; and
(c) when Q¹ and Q² are each an optionally substituted phenyl ring, then Q¹ is substituted with at least one R^{4a} at an otho position, or Q² is substituted with at least one R^{4b} at an otho position.

More particularly, this invention pertains to a compound selected from compounds of Formula 1 (including all stereoisomers) and N-oxides and salts thereof.

This invention also relates to a fungicidal composition comprising (a) a compound of the invention (i.e. in a fungicidally effective amount); and (b) at least one additional component selected from the group consisting of surfactants, solid diluents and liquid diluents.

This invention also relates to a fungicidal composition comprising (a) a compound of the invention; and (b) at least one other fungicide (e.g., at least one other fungicide having a different site of action).

This invention further relates to a method for controlling plant diseases caused by fungal plant pathogens comprising applying to the plant or portion thereof, or to the plant seed, a fungicidally effective amount of a compound of the invention (e.g., as a composition described herein).

### DETAILS OF THE INVENTION

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to in the present disclosure and claims, “plant” includes members of Kingdom Plantae, particularly seed plants (Spermatopsida), at all life stages, including young plants (e.g., germinating seeds developing into seedlings) and mature, reproductive stages (e.g., plants producing flowers and seeds). Portions of plants include geotropic members typically growing beneath the surface of the growing medium (e.g., soil), such as roots, tubers, bulbs and corms, and also members growing above the growing medium, such as foliage (including stems and leaves), flowers, fruits and seeds.

As referred to herein, the term “seedling”, used either alone or in a combination of words means a young plant developing from the embryo of a seed.

As used herein, the term “alkylating agent” refers to a chemical compound in which a carbon-containing radical is bound through a carbon atom to a leaving group such as halide or sulfonate, which is displaceable by bonding of a nucleophile to said carbon atom. Unless otherwise indicated, the term “alkylating” does not limit the carbon-containing radical to alkyl; the carbon-containing radicals in alkylating agents include the variety of carbon-bound substituent radicals specified for R¹ and R³.

In the above recitations, the term “alkyl”, used either alone or in compound words such as “alkylthio” or “haloalkyl” includes straight-chain or branched alkyl such as methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2- and 2,4-hexadienyl. “Alkynyl” includes straight-chain or branched alkynes such as ethynyl, 1-propynyl, 2-propynyl and the different butynyl, pentynyl and hexynyl isomers. “Alkynyl” also includes moieties comprised of multiple triple bonds such as 2,5-hexadiynyl. “Alkylene” denotes a straight-chain or branched alkanediyl. Examples of “alkylene” include CH₂, CH₂CH₂, CH(CH₃), CH₂CH₂CH₂, CH₂CH(CH₃), and the different butylene isomers. “Alkenylene” denotes a straight-chain or branched alkenediyl containing one olefinic bond. Examples of “alkenylene” include CH═CH, CH₂CH═CH, CH═C(CH₃) and the different butenylene isomers. “Cycloalkylene” and “cycloalkenylene” are defined analogously. “Alkynylene” denotes a straight-chain or branched alkynediyl containing one triple bond. Examples of “alkynylene” include C≡C, CH₂C≡C, C≡CCH₂, and the different butynylene isomers.

“Alkoxy” includes, for example, methoxy, ethoxy, n-propyloxy, i-propyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkylthio” includes branched or straight-chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(═O), CH₃CH₂S(═O), CH₃CH₂CH₂S(═O), (CH₃)₂CHS(═O) and the different butylsulfinyl, pentylsulfinyl and hexylsulfinyl isomers. Examples of “alkylsulfonyl” include CH₃S(═O)₂, CH₃CH₂S(═O)₂, CH₃CH₂CH₂S(═O)₂, (CH₃)₂CHS(═O)₂, and the different butylsulfonyl, pentylsulfonyl and hexylsulfonyl isomers. “Alkylthioalkyl” denotes alkylthio substitution on alkyl. Examples of “alkylthioalkyl” include CH₃SCH₂, CH₃SCH₂CH₂, CH₃CH₂SCH₂, CH₃CH₂CH₂CH₂SCH₂ and CH₃CH₂SCH₂CH₂; “alkylsulfinylalkyl” and “alkylsulfonylalkyl” include the corresponding sulfoxides and sulfones, respectively. “Hydroxyalkyl” denotes an alkyl group substituted with one hydroxy group. Examples of “hydroxyalkyl” include HOCH₂CH₂, CH₃CH₂(OH)CH and HOCH₂CH₂CH₂CH₂. “Cyanoalkyl” denotes an alkyl group substituted with one cyano group. Examples of “cyanoalkyl” include NCCH₂, NCCH₂CH₂ and CH₃CH(CN)CH₂. “Alkylamino”, “dialkylamino” and the like, are defined analogously to the above examples. “Alkylaminoalkyl” denotes alkylamino substitution on alkyl. Examples of “alkylaminoalkyl” include CH₃NHCH₂, CH₃NHCH₂CH₂, CH₃CH₂NHCH₂, CH₃CH₂CH₂CH₂NHCH₂ and CH₃CH₂NHCH₂CH₂. Examples of “dialkylaminoalkyl” include ((CH₃)₂CH)₂NCH₂, (CH₃CH₂CH₂)₂NCH₂ and CH₃CH₂(CH₃)NCH₂CH₂. The term “alkylcarbonylamino” denotes alkyl bonded to a C(═O)NH moiety. Examples of “alkylcarbonylamino” include CH₃CH₂C(═O)NH and CH₃CH₂C(═O)NH.

“Cycloalkyl” includes, for example, cyclopropyl, cyclobutyl, cyclopentyl and cyclohexyl. The term “alkylcycloalkyl” denotes alkyl substitution on a cycloalkyl moiety and includes, for example, ethylcyclopropyl, i-propylcyclobutyl, 3-methylcyclopentyl and 4-methylcyclohexyl. The term “cycloalkylalkyl” denotes cycloalkyl substitution on an alkyl moiety. Examples of “cycloalkylalkyl” include cyclopropylmethyl, cyclopentylethyl, and other cycloalkyl moieties bonded to straight-chain or branched alkyl groups.

The term “halogen”, either alone or in compound words such as “haloalkyl”, or when used in descriptions such as “alkyl substituted with halogen” includes fluorine, chlorine, bromine or iodine. Further, when used in compound words such as “haloalkyl”, or when used in descriptions such as “alkyl substituted with halogen” said alkyl may be partially or fully substituted with halogen atoms which may be the same or different. Examples of “haloalkyl” or “alkyl substituted with halogen” include F₃C, ClCH₂, CF₃CH₂ and CF₃CCl₂. The terms “halocycloalkyl”, “haloalkoxy”, “haloalkylthio”, “haloalkenyl”, “haloalkylsulfinyl”, “haloalkylsulfonyl” and the like, are defined analogously to the term “haloalkyl”. Examples of “halocycloalkyl” include 2-chlorocyclopropyl, 2-fluorocyclobutyl, 3-bromocyclopentyl and 4-chorocyclohexyl. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S. Examples of “haloalkenyl” include Cl₂C═CHCH₂ and CF₃CH₂CH═CHCH₂. Examples of “haloalkylsulfinyl” include CF₃S(═O), CCl₃S(═O), CF₃CH₂S(═O) and CF₃CF₂S(═O). Examples of “haloalkylsulfonyl” include CF₃S(═O)₂, CCl₃S(═O)₂, CF₃CH₂S(═O)₂ and CF₃CF₂S(═O)₂.

“Alkylcarbonyl” denotes a straight-chain or branched alkyl moiety bonded to a C(═O) group. Examples of “alkylcarbonyl” include CH₃C(═O), CH₃CH₂CH₂C(═O) and (CH₃)₂CHC(═O). Examples of “alkoxycarbonyl” include CH₃OC(═O), CH₃CH₂OC(═O), CH₃CH₂CH₂OC(═O), (CH₃)₂CHOC(═O) and the different butoxy- or pentoxycarbonyl isomers. “Cycloalkylcarbonyl” and “cycloalkoxycarbonyl” and the like, are defined analogously to the above examples.

“Alkyl(thiocarbonyl)” denotes a straight-chain or branched alkyl moiety bonded to a C(═S) group. Examples of “alkyl(thiocarbonyl)” include CH₃C(═S), CH₃CH₂CH₂C(═S) and (CH₃)₂CHC(═S). Examples of “alkoxy(thiocarbonyl)” include CH₃OC(═S), CH₃CH₂OC(═S), CH₃CH₂CH₂OC(═S), (CH₃)₂CHOC(═S) and the different butoxy- or pentoxycarbonyl isomers. “Cycloalkoxy(thiocarbonyl)” is defined analogously to the above examples.

“(Alkylthio)carbonyl” denotes a straight-chain or branched alkylthio moiety bonded to a C(═O) moiety. Examples of “(alkylthio)carbonyl” include CH₃SC(═O), CH₃CH₂SC(═O), CH₃CH₂CH₂SC(═O), (CH₃)₂CHSC(═O) and the different butylthio- or pentylthiocarbonyl isomers. “(Cycloalkylthio)carbonyl” is defined analogously to the above examples.

The total number of carbon atoms in a substituent group is indicated by the “Cᵢ-Cⱼ” prefix where i and j are numbers from 1 to 8. For example, C₁-C₄ alkylsulfonyl designates methylsulfonyl through butylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂.

The term “unsubstituted” in connection with a group such as a ring means the group does not have any substituents other than its one or more attachments to the remainder of Formula 1. The term “optionally substituted” means that the number of substituents can be zero. Unless otherwise indicated, optionally substituted groups may be substituted with as many optional substituents as can be accommodated by replacing a hydrogen atom with a non-hydrogen substituent on any available carbon or nitrogen atom. Commonly, the number of optional substituents (when present) range from 1 to 3. As used herein, the term “optionally substituted” is used interchangeably with the phrase “substituted or unsubstituted” or with the term “(un)substituted.”

The number of optional substituents may be restricted by an expressed limitation. For example, the phrase “optionally substituted with up to 4 substituents independently selected from R^{4a}” means that 0, 1, 2, 3 or 4 substituents can be present (if the number of potential connection points allows). When a compound is substituted with a substituent bearing a subscript that indicates the number of said substituents can exceed 1, said substituents (when they exceed 1) are independently selected from the group of defined substituents, e.g., (R^{4b})ₚ, wherein p is 1, 2, 3, 4 or 5. When a group contains a substituent which can be hydrogen, for example R¹ or R², then when this substituent is taken as hydrogen, it is recognized that this is equivalent to said group being unsubstituted. When a variable group is shown to be optionally attached to a position, for example (R^{4b})ₚ wherein p may be 0, then hydrogen may be at the position even if not recited in the variable group definition. When one or more positions on a group are said to be “not substituted” or “unsubstituted”, then hydrogen atoms are attached to take up any free valency.

Unless otherwise indicated, a “ring” as a component of Formula 1 (e.g., Q²) is carbocyclic (e.g., phenyl) or heterocyclic (e.g., pyridinyl). The term “ring member” refers to an atom (e.g., C, O, N or S) forming the backbone of a ring. Unless otherwise indicated, heterocyclic rings can be attached through any available carbon or nitrogen by replacement of a hydrogen on said carbon or nitrogen.

The terms “heterocyclic ring” or “heterocycle” denote a ring in which at least one atom forming the ring backbone is not carbon (e.g., N, O or S). Typically a heterocyclic ring contains no more than 3 N atoms, no more than 2 O atoms and no more than 2 S atoms. Unless otherwise indicated, a heterocyclic ring can be a saturated, partially unsaturated or fully unsaturated ring. When a fully unsaturated heterocyclic ring satisfies Hückel's rule, then said ring is also called a “heteroaromatic ring” or “aromatic heterocyclic ring”.

The term “nonaromatic” includes rings that are fully saturated as well as partially or fully unsaturated, provided that none of the rings are aromatic. The term “aromatic” indicates that each of the ring atoms of a fully unsaturated ring are essentially in the same plane and have a p-orbital perpendicular to the ring plane, and that (4n+2) π electrons, where n is a positive integer, are associated with the ring to comply with Hückel's rule.

In the context of the present invention when an instance of Q¹ and Q² comprises a phenyl or 6-membered heterocyclic ring (e.g., pyridinyl), the ortho, meta and para positions of each ring is relative to the connection of the ring to the remainder of Formula 1.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers or as an optically active form. Of note are atropisomers, which are stereoisomeric conformations of a molecule that occur when rotation about a single bond is restricted such that interconversion is slow enough to allow separation. Restricted rotation of one or more bonds is a result of steric interaction with other parts of the molecule. In the present invention, compounds of Formula 1 can exhibit atropisomerism when the energy barrier to free rotation around a single unsymmetrical bond is sufficiently high that separation of isomers is possible. Atropisomerism is defined to exist where the isomers have a half-life of at least 1000 seconds, which is a free energy barrier of at least about 22.3 kcal mol-1 at about 20° C. (Oki, Topics in Stereochemistry, Vol. 14, John Wiley & Sons, Inc., 1983). One skilled in the art will appreciate that one atropisomer may be more active and/or may exhibit beneficial effects when enriched relative to other atropisomers or when separated from other atropisomers. Additionally, the skilled artisan knows how to separate, enrich, and/or to selectively prepare said atropisomers. Further description of atropisomers can be found in March, Advanced Organic Chemistry, 101-102, 4^{th} Ed. 1992; Oki, Topics in Stereochemistry, Vol. 14, John Wiley & Sons, Inc., 1983 and Gawronski et al, Chirality 2002, 14, 689-702. This invention comprises enriched mixtures and essentially pure atropisomers of compounds of Formula 1.

One skilled in the art will appreciate that not all nitrogen containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of the compounds of Formula 1 are useful for control of plant diseases caused by fungal plant pathogens (i.e. are agriculturally suitable). The salts of the compounds of Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound of Formula 1 contains an acidic moiety such as a carboxylic acid or phenol, salts also include those formed with organic or inorganic bases such as pyridine, triethylamine or ammonia, or amides, hydrides, hydroxides or carbonates of sodium, potassium, lithium, calcium, magnesium or barium. Accordingly, the present invention comprises compounds selected from Formula 1, N-oxides and agriculturally suitable salts thereof.

Compounds selected from Formula 1, stereoisomers, tautomers, N-oxides, and salts thereof, typically exist in more than one form, and Formula 1 thus includes all crystalline and non-crystalline forms of the compounds that Formula 1 represents. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due to the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound represented by Formula 1 can exhibit beneficial effects (e.g., suitability for preparation of useful formulations, improved biological performance) relative to another polymorph or a mixture of polymorphs of the same compound represented by Formula 1. Preparation and isolation of a particular polymorph of a compound represented by Formula 1 can be achieved by methods known to those skilled in the art including, for example, crystallization using selected solvents and temperatures.

Embodiments of the present invention as described in the Summary of the Invention include those described below. In the following Embodiments, Formula 1 includes stereoisomers, N-oxides and salts thereof, and reference to “a compound of Formula 1” includes the definitions of substituents specified in the Summary of the Invention unless further defined in the Embodiments.

### Embodiment 1

A compound of Formula 1 wherein Q¹ is a phenyl, pyridinyl or pyrimidinyl ring, each ring optionally substituted with up to 3 substituents independently selected from R^{4a}.

### Embodiment 2

A compound of Embodiment 1 wherein Q¹ is a phenyl or pyridinyl ring, each ring optionally substituted with up to 3 substituents independently selected from R^{4a}.

### Embodiment 3

A compound of Embodiment 2 wherein Q¹ is a phenyl ring optionally substituted with up to 3 substituents independently selected from R^{4a}.

### Embodiment 4

A compound of Embodiment 3 wherein Q¹ is a phenyl ring substituted with 1 to 3 substituents independently selected from R^{4a}.

### Embodiment 5

A compound of Embodiment 4 wherein Q¹ is a phenyl ring substituted with 3 substituents independently selected from R^{4a}.

### Embodiment 6

A compound of Embodiment 4 wherein Q¹ is a phenyl ring substituted with 2 substituents independently selected from R^{4a}.

### Embodiment 7

A compound of Embodiment 4 wherein Q¹ is a phenyl ring substituted with 1 substituent selected from R^{4a}.

### Embodiment 8

A compound of Formula 1 or any one of Embodiments 1 through 7 wherein Q² is a phenyl, pyridinyl or pyrimidinyl ring, each ring optionally substituted with up to 3 substituents independently selected from R^{4b}.

### Embodiment 9

A compound of Embodiment 8 wherein Q² is a phenyl or pyridinyl ring, each ring optionally substituted with up to 3 substituents independently selected from R^{4b}.

### Embodiment 10

A compound of Embodiment 9 wherein Q² is a phenyl ring optionally substituted with up to 3 substituents independently selected from R^{4b}.

### Embodiment 11

A compound of Embodiment 10 wherein Q² is a phenyl ring substituted with 1 to 3 substituents independently selected from R^{4b}.

### Embodiment 12

A compound of Embodiment 11 wherein Q² is a phenyl ring substituted with 3 substituents independently selected from R^{4b}.

### Embodiment 13

A compound of Embodiment 12 wherein Q² is a phenyl ring substituted with 2 substituents independently selected from R^{4b}.

### Embodiment 14

A compound of Embodiment 13 wherein Q² is a phenyl ring substituted with 1 substituent selected from R^{4b}.

### Embodiment 15

A compound of Formula 1 or any one of Embodiments 1 through 14 wherein when Q¹ and Q² are each a phenyl ring substituted with 1 to 3 substituents independently selected from R^{4a} and R^{4b}, then one of Q¹ and Q² is substituted with 2 or 3 substituents and the other of Q¹ and Q² is substituted with 1 to 3 substituents.

### Embodiment 16

A compound of Formula 1 or any one of Embodiments 1 through 15 wherein when Q¹ and Q² are each a phenyl ring substituted with 1 to 3 substituents independently selected from R^{4a} and R^{4b}, then one of Q¹ and Q² is substituted with 2 or 3 substituents and the other of Q¹ and Q² is substituted with 1 or 2 substituents.

### Embodiment 17

A compound of Formula 1 or any one of Embodiments 1 through 16 wherein R¹ and R² are each independently H, halogen, C₁-C₃ alkyl, C₁-C₃ haloalkyl or cyclopropyl.

### Embodiment 18

A compound of Embodiment 17 wherein R¹ and R² are each independently H, halogen, methyl or cyclopropyl.

### Embodiment 19

A compound of Embodiment 18 wherein R¹ and R² each independently halogen or methyl.

### Embodiment 20

A compound of Embodiment 19 wherein R¹ and R² each independently Cl, Br or methyl.

### Embodiment 21

A compound of Embodiment 20 wherein R¹ and R² each independently Cl or Br.

### Embodiment 22

A compound of Embodiment 20 wherein R¹ and R² each methyl.

### Embodiment 23

A compound of Formula 1 or any one of Embodiments 1 through 22 wherein R³ is H, hydroxy, —CH(═O), C₁-C₃ alkyl, C₁-C₃ haloalkyl, C₂-C₃ alkoxyalkyl, C₁-C₃ alkoxy, C₁-C₃ alkylsulfinyl, C₁-C₃ alkylsulfonyl, C₂-C₃ alkylcarbonyl, C₂-C₃ alkoxycarbonyl or —S(═O)₂OM.

### Embodiment 24

A compound Embodiment 23 wherein R³ is H or methyl.

### Embodiment 25

A compound of Embodiment 24 wherein R³ is H.

### Embodiment 26

A compound of Formula 1 or any one of Embodiments 1 through 25 wherein each R^{4a} and R^{4b} is independently halogen, cyano, C₁-C₂ alkyl, C₁-C₂ haloalkyl, cyclopropyl, C₁-C₂ alkoxy, C₁-C₃ alkylthio, C₁-C₂ alkylamino, C₂-C₄ dialkylamino, C₂-C₄ alkylcarbonyl or -T-U—V.

Embodiment 27. A compound of Embodiment 26 wherein each R^{4a} and R^{4b} is independently halogen, cyano, C₁-C₂ alkyl, C₁-C₂ haloalkyl or C₁-C₂ alkoxy.

### Embodiment 28

A compound of Embodiment 27 wherein each R^{4a} and R^{4b} is independently halogen, cyano, methyl, halomethyl or methoxy.

### Embodiment 29

A compound of Embodiment 28 wherein each R^{4a} and R^{4b} is independently Br, Cl, F, cyano, methyl, trifluoromethyl or methoxy.

### Embodiment 30

A compound of Embodiment 29 wherein each R^{4a} and R^{4b} is independently Br, Cl or F.

### Embodiment 31

A compound of Formula 1 or any one of Embodiments 1 through 30 wherein at least one R^{4a} substituent is attached at an ortho position of Q¹ (relative to the connection of Q¹ to the remainder of Formula 1).

### Embodiment 32

A compound of Formula 1 or any one of Embodiments 1 through 31 wherein at least one R^{4a} substituent is attached at the para position of Q¹ (relative to the connection of Q¹ to the remainder of Formula 1).

### Embodiment 33

A compound of Formula 1 or any one of Embodiments 1 through 32 wherein two R^{4a} substituents are attached at the ortho positions of Q¹ (relative to the connection of Q¹ to the remainder of Formula 1).

### Embodiment 34

A compound of Formula 1 or any one of Embodiments 1 through 33 wherein one R^{4a} substituent is attached at the para position and one R^{4a} substituent is attached at the ortho position of Q¹ (relative to the connection of Q¹ to the remainder of Formula 1).

### Embodiment 35

A compound of Formula 1 or any one of Embodiments 1 through 34 wherein at least one R^{4b} substituent is attached at an ortho position of Q² (relative to the connection of Q² to the remainder of Formula 1).

### Embodiment 36

A compound of Formula 1 or any one of Embodiments 1 through 35 wherein at least one R^{4b} substituent is attached at the para position of Q² (relative to the connection of Q² to the remainder of Formula 1).

### Embodiment 37

A compound of Formula 1 or any one of Embodiments 1 through 36 wherein two R^{4b} substituents are attached at the ortho positions of Q² (relative to the connection of Q² to the remainder of Formula 1).

### Embodiment 38

A compound of Formula 1 or any one of Embodiments 1 through 37 wherein one R^{4b} substituent is attached at the para position and one R^{4b} substituent is attached at the ortho position of Q² (relative to the connection of Q² to the remainder of Formula 1).

### Embodiment 39

A compound of Formula 1 or any one of Embodiments 1 through 38 wherein when Q¹ and Q² are each a phenyl ring substituted with 2 substituents independently selected from R^{4a} and R^{4b}, then the R^{4a} and R^{4b} substituents are attached to the para and ortho positions (relative to the connection of Q¹ and Q² to the remainder of Formula 1).

### Embodiment 40

A compound of Formula 1 or any one of Embodiments 1 through 38 wherein when Q¹ and Q² are each a phenyl ring substituted with 2 substituents independently selected from R^{4a} and R^{4b}, then the R^{4a} and R^{4b} substituents are attached to one of Q¹ and Q² rings at the para and ortho positions and attached to the other ring at the ortho positions (relative to the connection of Q¹ and Q² to the remainder of Formula 1).

### Embodiment 41

A compound of Formula 1 or any one of Embodiments 1 through 40 wherein each T is independently O, NR⁵ or a direct bond.

### Embodiment 42

A compound of Embodiment 41 wherein each R⁵ is independently H or methyl.

### Embodiment 43

A compound of Embodiment 41 wherein each T is independently O, NH or a direct bond.

### Embodiment 44

A compound of Formula 1 or any one of Embodiments 1 through 43 wherein each U is independently C₁-C₄ alkylene, wherein up to 1 carbon atom is selected from C(═O).

### Embodiment 45

A compound of Embodiment 44 wherein each U is independently C₁-C₃ alkylene.

### Embodiment 46

A compound of Formula 1 or any one of Embodiments 1 through 45 wherein each V is independently N(R^{6a})(R^{6b}) or OR⁷.

### Embodiment 47

A compound of Formula 1 or any one of Embodiments 1 through 46 wherein each R^{6a} and R^{6b} is independently H, C₁-C₆ alkyl or C₁-C₆ haloalkyl.

### Embodiment 48

A compound of Embodiment 47 wherein each R^{6a} and R^{6b} is independently H or methyl.

### Embodiment 49

A compound of Formula 1 or any one of Embodiments 1 through 46 wherein each R⁷ is independently H, C₁-C₆ alkyl or C₁-C₆ haloalkyl.

### Embodiment 50

A compound of Embodiment 49 wherein each R⁷ is independently H, methyl or halomethyl.

### Embodiment 51

A compound of Formula 1 or any one of Embodiments 1 through 50 wherein each W is O.

Embodiments of this invention, including Embodiments 1-51 above as well as any other embodiments described herein, can be combined in any manner, and the descriptions of variables in the embodiments pertain not only to the compounds of Formula 1 but also to the starting compounds and intermediate compounds useful for preparing the compounds of Formula 1. In addition, embodiments of this invention, including Embodiments 1-51 above as well as any other embodiments described herein, and any combination thereof, pertain to the compositions and methods of the present invention.

Combinations of Embodiments 1-51 are illustrated by:

### Embodiment A1

A compound of Formula 1 wherein
Q¹ is a phenyl, pyridinyl or pyrimidinyl ring, each ring optionally substituted with up to 3 substituents independently selected from R^{4a};
Q² is a phenyl, pyridinyl or pyrimidinyl ring, each ring optionally substituted with up to 3 substituents independently selected from R^{4b}; R¹ and R² are each independently H, halogen, C₁-C₃ alkyl, C₁-C₃ haloalkyl or cyclopropyl;
R³ is H, hydroxy, —CH(═O), C₁-C₃ alkyl, C₁-C₃ haloalkyl, C₂-C₃ alkoxyalkyl, C₁-C₃ alkoxy, C₁-C₃ alkylsulfinyl, C₁-C₃ alkylsulfonyl, C₂-C₃ alkylcarbonyl, C₂-C₃ alkoxycarbonyl or —S(═O)₂OM;
each R^{4a} and R^{4b} is independently halogen, cyano, C₁-C₂ alkyl, C₁-C₂ haloalkyl, cyclopropyl, C₁-C₂ alkoxy, C₁-C₃ alkylthio, C₁-C₂ alkylamino, C₂-C₄ dialkylamino, C₂-C₄ alkylcarbonyl or -T-U—V;
each T is independently O, NH or a direct bond;
each U is independently C₁-C₃ alkylene, wherein up to 1 carbon atom is selected from C(═O);
each V is independently N(R^{6a})(R^{6b}) or OR⁷;
each R^{6a} and R^{6b} is independently H or methyl; and
each R⁷ is independently H, methyl or halomethyl.

### Embodiment A2

A compound of Embodiment A1 wherein
Q¹ is a phenyl or pyridinyl ring, each ring optionally substituted with up to 3 substituents independently selected from R^{4a};
Q² is a phenyl or pyridinyl ring, each ring optionally substituted with up to 3 substituents independently selected from R^{4b};
R¹ and R² are each independently H, halogen, methyl or cyclopropyl;
R³ is H or methyl; and
each R^{4a} and R^{4b} is independently halogen, cyano, C₁-C₂ alkyl, C₁-C₂ haloalkyl or C₁-C₂ alkoxy.

### Embodiment A3

A compound of Embodiment A2 wherein
Q¹ is a phenyl ring optionally substituted with up to 3 substituents independently selected from R^{4a};
Q² is a phenyl ring optionally substituted with up to 3 substituents independently selected from R^{4b};
R¹ and R² are each independently halogen or methyl;
R³ is H; and
each R^{4a} and R^{4b} is independently halogen, cyano, methyl, halomethyl or methoxy.

### Embodiment A4

A compound of Embodiment A3 wherein
Q¹ is a phenyl ring substituted with 1 to 3 substituents independently selected from R^{4a};
Q² is a phenyl ring substituted with 1 to 3 substituents independently selected from R^{4b};
R¹ and R² are each independently Cl, Br or methyl; and
each R^{4a} and R^{4b} is independently Br, Cl, F, cyano, methyl, trifluoromethyl or methoxy.

### Embodiment A5

A compound of Embodiment A4 wherein
one of Q¹ and Q² is substituted with 2 or 3 substituents and the other of Q¹ and Q² is substituted with 1 or 2 substituents; and
each R^{4a} and R^{4b} is independently Br, Cl or F.

Specific embodiments include compounds of Formula 1 selected from the group consisting of:
N-(2-chloro-4-fluorophenyl)-5-(2,4-difluorophenyl)-4-methyl-1H-imidazol-1-amine (Compound 1);
2-bromo-N-(2-chloro-4-fluorophenyl)-5-(2,4-difluorophenyl)-4-methyl-1H-imidazol-1-amine (Compound 2);
N-(2,4-chlorophenyl)-5-(2,4-difluorophenyl)-4-methyl-1H-imidazol-1-amine (Compound 7);
2-bromo-N-(2-bromo-4,6-chlorophenyl)-5-(2,4-difluorophenyl)-4-methyl-1H-imidazol-1-amine (Compound 8); and
2-bromo-N,5-bis(2,4-difluorophenyl)-4-methyl-1H-imidazol-1-amine (Compound 10).

This invention provides a fungicidal composition comprising a compound of Formula 1 (including all stereoisomers, N-oxides, and salts thereof), and at least one other fungicide. Of note as embodiments of such compositions are compositions comprising a compound corresponding to any of the compound embodiments described above.

This invention provides a fungicidal composition comprising a compound of Formula 1 (including all stereoisomers, N-oxides, and salts thereof) (i.e. in a fungicidally effective amount), and at least one additional component selected from the group consisting of surfactants, solid diluents and liquid diluents. Of note as embodiments of such compositions are compositions comprising a compound corresponding to any of the compound embodiments described above.

This invention provides a method for controlling plant diseases caused by fungal plant pathogens comprising applying to the plant or portion thereof, or to the plant seed, a fungicidally effective amount of a compound of Formula 1 (including all stereoisomers, N-oxides, and salts thereof). Of note as embodiments of such methods are methods comprising applying a fungicidally effective amount of a compound corresponding to any of the compound embodiments describe above. Of particular note are embodiments where the compounds are applied as compositions of this invention.

One or more of the following methods and variations as described in Schemes 1-12 can be used to prepare the compounds of Formula 1. The definitions of R¹, R², R³, Q¹ and Q² in the compounds of Formulae 1-10 below are as defined above in the Summary of the Invention unless otherwise noted. Compounds of Formulae 1a-1i are various subsets of the compounds of Formula 1, and all substituents for Formulae 1a-1i are as defined above for Formula 1.

As shown in Scheme 1, compounds of Formula 1a (i.e. Formula 1 wherein R¹ is H) can be prepared by oxidative reduction of cyclic thiosemicarbazides of Formula 2 with hydrogen peroxide. Typically the reaction is carried out in a solvent such as acetic acid at a temperature between 0 and 30° C. Conditions for effecting this transformation can be found in Heterocycles 1998, 48 (5), 929-938 and Journal of Medicinal Chemistry 2003, 46, 1546-1553. Also, the method of Scheme 1 is illustrated in present Example 1, Step D and Example 3, Step B.

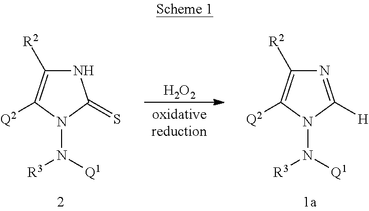

As shown in Scheme 2, cyclic thiosemicarbazides of Formula 2 can be prepared by bromination of ketones of Formula 3 followed by treatment of the resulting α-bromoketones of Formula 4 with hydrazines of Formula 5 in the presence of potassium isothiocyanate. Conditions for effecting this transformation can be found in Heterocycles 1997, 45, 691-700 and Journal of Medicinal Chemistry 2003, 46, 1546-1553. Also, the method of Scheme 2 is illustrated in present Example 1, Step C and Example 3, Step A.

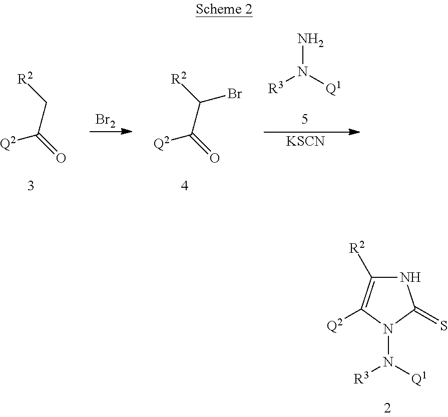

As shown in Scheme 3, compounds of Formula 1a wherein R³ is other than H can be prepared from compounds of Formula 1b (i.e. Formula 1 wherein R¹ and R³ are H) by treatment with sodium hydride followed by quenching of the resulting anion with electrophiles of formula R³-Lg (wherein Lg is a suitable leaving group) such as alkyl halides, alkyl sulfonates, acyl halides, sulfenyl halides, sulfinyl halides, sulfonyl halide and the like. A representative example of such a procedure can be found in Journal of Organic Chemistry 2011, 76, 1468-1471.

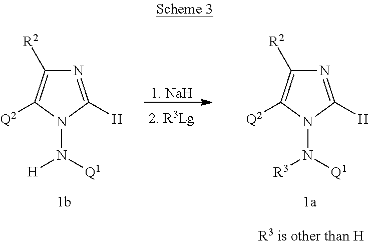

As shown in Scheme 4, compounds of Formula 1c (i.e. Formula 1 wherein R¹ is halogen) can be prepared by treating compounds of Formula 1a with a halogenating reagent such as N-bromosuccinimide (NBS), N-chlorosuccinimide (NCS) or N-iodosuccinimide (NIS). Typically the reaction is carried out in a solvent such as chloroform, methylene chloride or acetonitrile at a temperature between 0 and 80° C., either in the presence of light or in the presence of a radical initiator such as benzoyl peroxide or azobisisobutyronitrile (AIBN). General procedures for halogenations of this type can be found in Tetrahedron Letters 2007, 48, 2275-2255. Example 2 illustrates this method using NBS.

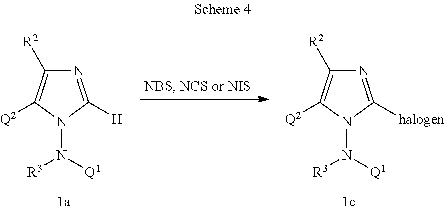

As shown in Scheme 5, compounds of Formula 1d (i.e. Formula 1 wherein R² is halogen and R¹ is hydrogen) can be prepared by halogenation of compounds of Formula 6 using conditions analogous to those described in Scheme 4. To obtain compounds of Formula 1e wherein R¹ and R² are both halogen, compounds of Formula 1d can be treated with a second equivalent of the same halogenating reagent (for R¹ and R² being the same halogen) or a different halogenating reagent (for R¹ and R² being different halogens) using appropriate variations of the method of Scheme 4. Example 3, Step C illustrates the preparation of a compound of Formula 1e wherein R¹ and R² are both chlorine. Alternatively halogenation can be achieved by reacting compounds of Formula 1d with a metalating reagent, followed by a halogenating reagent. Suitable metalating agents include, for example, as n-butyl lithium (n-BuLi), lithium diisopropylamide (LDA) or sodium hydride (NaH). A wide variety of halogenating reagents can be used in the method of Scheme 5 such as, for example, N-halosuccinimide, hexachloroethane, 1,2-dibromotetrachloroethane, carbon tetrabromide, hexachloroethane or Accufluor® (e.g., N-fluorobis(phenylsulfonyl)amine).

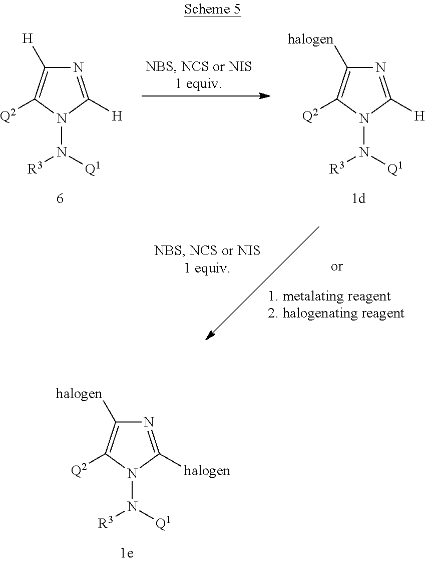

As shown in Scheme 6, compounds of Formula 1f (i.e. Formula 1 wherein R¹ is halogen and R³ is H) can be prepared from compounds of Formula 1b. In this method, Compounds of Formula 1b are first N-protected with a protecting group (PG) such as tert-butoxycarbonyl or benzyloxycarbonyl to afford compounds of Formula 7. Transformation of compounds of Formula 7 to compounds of Formula 8 can be carried out using conditions analogous to those described in Scheme 4. N-deprotection of compounds of Formula 8 affords compounds of Formula 1f. Methods for N-protection and N-deprotection useful in this method can be found in Greene, Protective Groups in Organic Synthesis, John Wiley and Sons, New York, 1981.

In a subsequent step, Compounds of Formula 1f can be transformed into compounds of Formula 1c wherein R³ is other than H using a method analogous to the one described in Scheme 3.

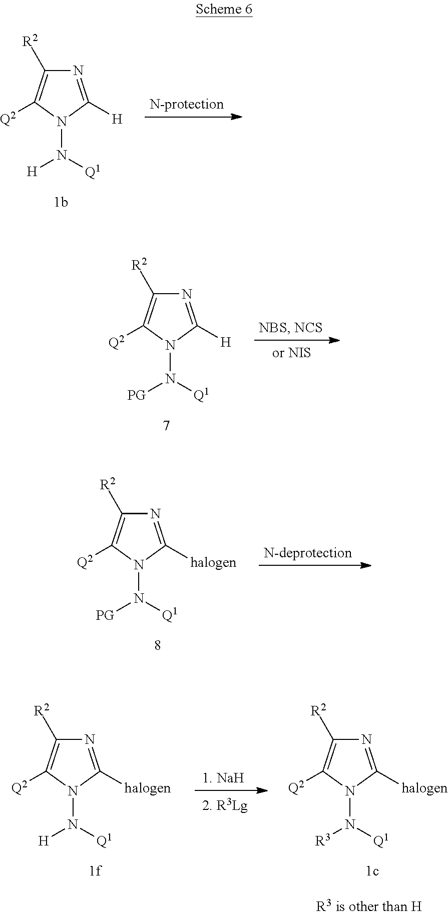

As shown Scheme 7, compounds of Formula 1 wherein R¹ is alkyl, alkenyl, alkynyl, and the like can be prepared by coupling compounds of Formula 1c with boronates of Formula 9 using Suzuki reaction conditions. Suzuki couplings are well-documented in the literature (see for example Angewandte Chemie International Edition, 2006, 45, 3484, Tetrahedron Letters, 2002, 58(14), 2885 and PCT Patent Publications WO 2008/119741, WO 2010/093885 and WO 2011/076725). Boron intermediates of Formula 9 are commercially available and can be prepared by methods known in the literature.

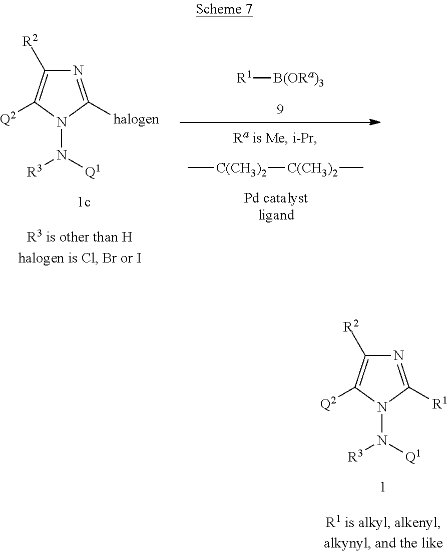

As shown in Scheme 8, compounds of Formula 1 wherein R³ is other than H and R¹ is alkyl, alkylthio, haloalkyl, alkenyl, haloalkenyl, alkynyl, and the like, can be prepared from compounds of Formula 1a by metalation with a reagent such as n-butyllithium (n-BuLi), lithium diisopropylamide (LDA) or sodium hydride (NaH) in a solvent such as tetrahydrofuran, dioxane or toluene at temperatures ranging from about 0° C. to room temperature. The anion is then contacted with an electrophile resulting in the introduction of an R¹ group onto the imidazole at the 2-position. For alkylation, the electrophile can be an alkylating agent of the formula R¹-Lg wherein Lg is a leaving group such as Cl, Br, I, or a sulfonate (e.g., p-toluenesulfonate, methanesulfonate or trifluoromethanesulfonate) and R¹ is alkyl, alkylthio, haloalkyl, alkenyl, haloalkenyl, alkynyl, and the like. Alternatively, symmetrical electrophiles such as dialkylsulfides can be used to provide compounds of Formula 1 wherein R¹ is alkylthio. There are a wide-variety of general methods described in the synthetic literature for metalation/alkylation reactions which can be readily adapted to prepare compounds of the present invention; see, for example, Grimmett, M. R. in Comprehensive Heterocyclic Chemistry; Katritsky, A. R., Rees, C. W., and Schriven, E. F. V., Eds.; Pergamon Press, Oxford, 1966; Vol. 3, p. 77; Progress in Heterocyclic Chemistry 1999, 11, 21 and references cited therein; Tetrahedron Letters, 2009, 50, 5194; and PCT Patent Publication WO2012/044650.

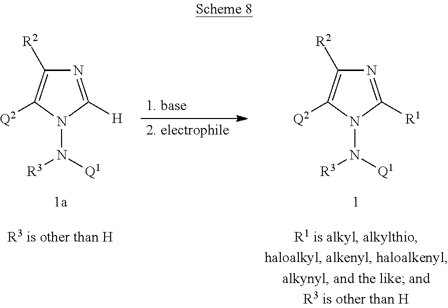

As shown in Scheme 9, compounds of Formula 1 wherein R¹ is alkyl, alkylthio, haloalkyl, alkenyl, alkynyl, and the like, and R³ is H and can be prepared by treatment of N-protected intermediates of Formula 7 under conditions analogous to those described in Scheme 8 followed by N-deprotection of compounds of Formula 10 using conditions analogous to those described in Scheme 6.

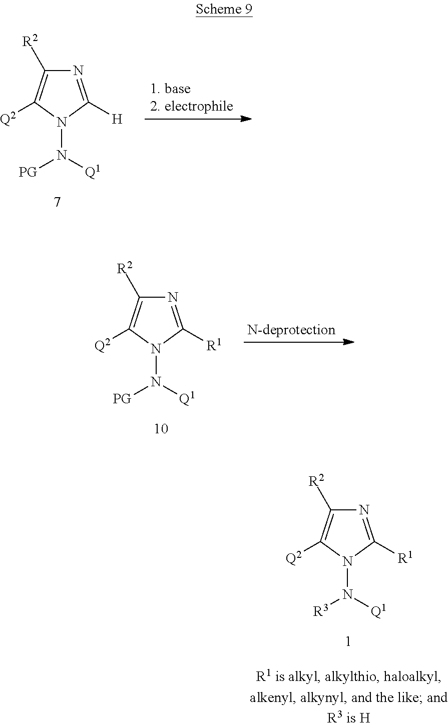

As shown in Scheme 10, compounds of Formula 1g (i.e. Formula 1 wherein R¹ is CN and R³ is other than H) can be prepared from 2-haloimidazoles of Formula 1c by treatment with a metal cyanide such as sodium cyanide in a polar aprotic solvent such as N,N-dimethylformamide. A representative procedure for effecting this transformation can be found in European Journal of Medicinal Chemistry, 2011, 46, 417-422. As also shown in Scheme 8, compounds of Formula 1g can be prepared from 2-haloimidazoles of Formula 1c using metal-catalyzed cross coupling reaction conditions such as those described in Acta Chemica Scandinavica 1996, 50, 58-63 and Journal of the American Chemical Society 2009, 131, 623-633.

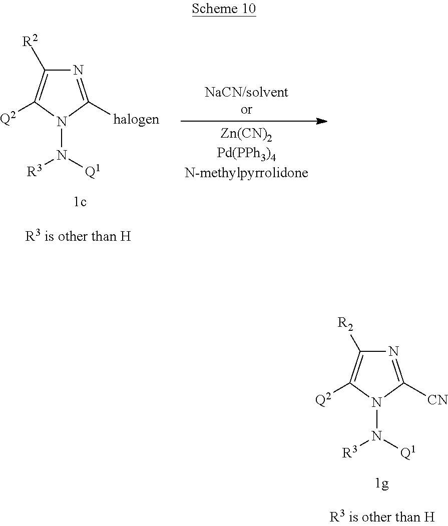

As shown in Scheme 11, compounds of Formula 1 wherein R¹ is alkoxy, haloalkoxy, alkylthio and haloalkylthio and R³ is other than H can be prepared from compounds of Formula 1c by treatment with the appropriate alcohol or thiol in the presence of base.

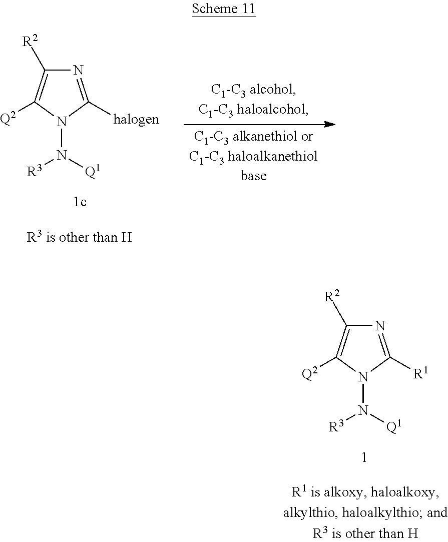

As shown in Scheme 12, compounds of Formula 1h (i.e. Formula 1 wherein R³ is hydroxy) can be prepared by treatment of compounds of Formula 1i (i.e. Formula 1 wherein R³ is H, prepared by the method of Scheme 9) with dimethyldioxirane under conditions described in Synthetic Communications, 1989, 19 (20), 3509-3522.

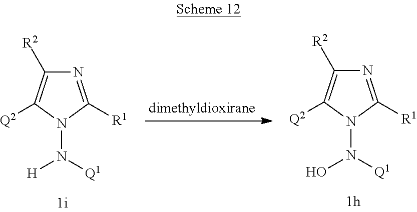

It is recognized that some reagents and reaction conditions described above for preparing compounds of Formula 1 may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1.

One skilled in the art will also recognize that compounds of Formula 1 and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Steps in the following Examples illustrate a procedure for each step in an overall synthetic transformation, and the starting material for each step may not have necessarily been prepared by a particular preparative run whose procedure is described in other Examples or Steps. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane in CDCl₃ unless otherwise noted; “s” means singlet, “d” means doublet, “t” means triplet, “q” means quartet, “m” means multiplet, “dd” means doublet of doublets, “dt” means doublet of triplets and “br s” means broad singlet.

### Example 1

### Preparation of 5-(2,4-difluorophenyl)-N-(2,4-dichlorophenyl)-4-methyl-1H-imidazol-1-amine (Compound 7)

### Step A: Preparation of 2-bromo-1-(2,4-difluorophenyl)-1-propanone

To a mixture of 2,4-difluoropropiophenone (2.0 g, 11.75 mmol) in chloroform (50 mL) was added bromine (2.065 g, 12.93 mmol) dropwise at room temperature. The reaction mixture was stirred vigorously for 15 minutes, and then concentrated under reduced pressure to provide the title compound as an oil (2.93 g).

¹H NMR δ 7.97 (q, 1H), 7.01 (t, 1H), 6.90 (dt, 1H), 5.24 (q, 1H), 1.89 (d, 3H).

### Step B: Preparation of 2-(2,4-difluorophenyl)-1-methyl-2-oxoethyl ester thiocyanic acid

To a mixture of 2-bromo-1-(2,4-difluorophenyl)-1-propanone (i.e. the product of Step A) (2.93 g, 11.75 mmol) in acetic acid (10 mL) was added potassium thiocyanate (1.25 g, 12.93 mmol). The reaction mixture was stirred for 18 h, and then added to water (50 mL) and extracted with ethyl acetate (3×100 mL). The combined organic extracts were dried over magnesium sulfate, filtered and concentrated under reduced pressure to give the title compound as a solid (2.67 g).

¹H NMR δ 8.01 (q, 1H), 7.04 (t, 1H), 6.93 (dt, 1H), 4.77 (q, 1H), 1.80 (d, 3H).

### Step C: Preparation of 1-[(2,4-dichlorophenyl)amino]-5-(2,4-difluorophenyl)-1,3-dihydro-4-methyl-2H-imidazole-2-thione

To a stirred solution of the 2-(2,4-difluorophenyl)-1-methyl-2-oxoethyl ester thiocyanic acid (i.e. the product of Step B) (2.0 g, 8.80 mmol) and potassium thiocyanate (1.71 g, 17.60 mmol) in acetic acid (50 mL) was added 2,4-dichlorophenylhydrazine hydrochloride (1.88 g, 8.80 mmol). This reaction mixture was stirred at room temperature for 24 h, followed by heating at 80° C. for 4 h. The reaction mixture was added to water (100 mL) and extracted with ethyl acetate (3×100 mL). The combined organic extracts were dried over magnesium sulfate and filtered. Celite® (diatomaceous filter aid) was added to the filtrate and the resulting mixture was concentrated under reduced pressure. The resulting solid was purified by chromatography on silica gel eluting with 0 to 50% ethyl acetate:hexane to give the title compound as a solid (536 mg).

¹H NMR δ 7.73 (s, 1H), 7.19 (s, 1H), 7.09-7.12 (m, 2H), 6.99 (d, 1H), 6.94 (br s, 1H), 6.86 (q, 1H), 2.64 (br s, 1H), 2.23 (s, 3H).

### Step D: Preparation of 5-(2,4-difluorophenyl)-N-(2,4-dichlorophenyl)-4-methyl-1H-imidazol-1-amine

To a mixture of 1-[(2,4-dichlorophenyl)amino]-5-(2,4-difluorophenyl)-1,3-dihydro-4-methyl-2H-imidazole-2-thione (i.e. the product of Step C) (530 mg, 1.37 mmol) in acetic acid (5 mL) at room temperature was added 50% aqueous hydrogen peroxide (1 mL). The reaction mixture was stirred for 15 minutes and then water (10 mL) was added. The resulting solid precipitate was filtered and dried under reduced pressure at 80° C. for 18 h to give the title compound, a compound of the present invention, as a white solid (458 mg).

¹H NMR δ 7.72 (s, 1H), 7.18 (s, 1H), 7.08-7.12 (m, 2H), 7.00 (d, 1H), 6.84-6.98 (m, 2H), 2.23 (s, 3H).

### Example 2

### Preparation of N-(2-bromo-4,6-dichlorophenyl)-4-methyl-2-bromo-5-(2,4-difluorophenyl)-1H-imidazol-1-amine (Compound 8)

To a mixture of 5-(2,4-difluorophenyl)-N-(2,4-dichlorophenyl)-4-methyl-1H-imidazol-1-amine (i.e. the product of Example 1, Step D) (450 mg, 1.27 mmol) in chloroform (10 mL) was added N-bromosuccinimide (226 mg, 1.27 mmol). The reaction mixture was stirred at room temperature for 3 h under a 600 watt incandescent halogen lamp. Celite® (diatomaceous filter aid) was added to the reaction mixture and the solvent removed under reduced pressure. The resulting material was purified by column chromatography on silica gel eluting with 0 to 100% ethyl acetate:hexane to provide the title compound, a compound of the present invention, as a solid (20.2 mg).

¹H NMR δ 7.30 (s, 1H), 7.19 (s, 1H), 7.16 (s, 1H), 7.14 (m, 1H), 6.82-6.89 (m, 2H), 2.13 (s, 3H).

### Example 3

### Preparation of N-(2-chloro-4,6-difluorophenyl)-2,4-dichloro-5-(2,4-dichlorophenyl)-1H-imidazol-1-amine (Compound 11)

### Step A: Preparation of 1-[(2,4-difluorophenyl)amino]-5-(2,4-dichlorophenyl)-1,3-dihydro-2H-imidazole-2-thione

To a mixture of 2-(2,4-dichlorophenyl)-2-oxoethyl thiocyanate (5.0 g, 20.33 mmol) and potassium thiocyanate (4.35 g, 44.72 mmol) in acetic acid (100 mL) was added 2,4-difluorophenylhydrazine hydrochloride (4.03 g, 22.36 mmol). The reaction mixture was stirred at room temperature for 48 h, and then heated at 80° C. for 6 h. The reaction mixture was added to water (100 mL) and extracted with ethyl acetate (3×100 mL). The combined organic extracts were dried over magnesium sulfate and filtered. Celite® (diatomaceous filter aid) was added to the filtrate and the resulting mixture was concentrated under reduced pressure. The resulting solid was purified by chromatography on silica gel eluting with 0 to 50% ethyl acetate:hexane to provide the title compound as a solid (4.11 g).

¹H NMR δ 8.32 (s, 1H), 7.62 (d, 1H), 7.33 (s, 1H) 7.31-7.33 (m, 1H), 6.71 (s, 1H), 6.62-6.70 (m, 2H), 6.51-6.56 (m, 1H), 1.78 (br s, 1H).

### Step B: Preparation of 5-(2,4-dichlorophenyl)-N-(2,4-difluorophenyl)-1H-imidazol-1-amine

To a solution of the 1-[(2,4-difluorophenyl)amino]-5-(2,4-dichlorophenyl)-1,3-dihydro-2H-imidazole-2-thione (i.e. the product of Step A) (4.11 g, 10.64 mmol) in acetic acid (50 mL) was added 50% aqueous hydrogen peroxide (8 mL). The reaction mixture was stirred at room temperature for 15 minutes and then water (10 mL) was added. The resulting solid precipitate was filtered and dried under reduced pressure at 80° C. for 18 h to give the title compound as a white solid (3.78 g).

¹H NMR δ 7.45 (s, 1H), 7.21-7.22 (m, 2H), 6.89 (s, 1H) 6.69-6.74 (m, 2H), 6.52-6.58 (m, 1H), 5.91 (s, 1H), 4.90 (br s, 1H).

### Step C: Preparation of N-(2-chloro-4,6-difluorophenyl)-2,4-dichloro-5-(2,4-dichlorophenyl)-1H-Imidazol-1-amine

To a solution of 5-(2,4-dichlorophenyl)-N-(2,4-difluorophenyl)-1H-imidazol-1-amine (i.e. the product of Step B) (500 mg, 1.47 mmol) in chloroform (10 mL) was added N-chlorosuccinimide (393 mg, 2.94 mmol). The reaction mixture was stirred at room temperature for 3 h under a halogen lamp. Celite® (diatomaceous filter aid) was added to the reaction mixture and the solvent was removed under reduced pressure. The resulting solid was purified by column chromatography on silica gel eluting with 0 to 50% ethyl acetate:hexane to provide the title compound, a compound of the present invention, as a solid (20.2 mg).

¹H NMR δ 7.55-7.58 (m, 2H), 7.36 (dd, 1H), 7.14 (dt, 1H), 6.95-7.00 (m, 1H), 5.30 (s, 1H).

By the procedures described herein together with methods known in the art, the following compounds of Tables 1 to 2 can be prepared. The following abbreviations are used in the Tables which follow: c means cyclo, Me means methyl, Ph means phenyl, OMe means methoxy, OEt means ethoxy, —CN means cyano and Ph means phenyl.

TABLE 1

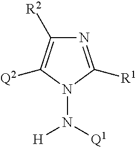

Q¹ is 4-F—Ph, R¹ is H, R² is Me
Q²
2-Br—Ph
2-Cl—Ph
2-F—Ph
2-I—Ph
2-CF₃—Ph
2,4-di-Cl—Ph
2,6-di-Cl—Ph
2,4-di-F—Ph
2,6-di-F—Ph
2-Br-4-Cl—Ph
2-Br-4-CN—Ph
2-Br-4-F—Ph
2-Br-6-F—Ph
2-Br-4-Cl-6-F—Ph
2-Cl-3-pyridinyl
3,5-di-Cl-2-pyridinyl
2-Br-4-MeO—Ph
2-Br-4-EtO—Ph
2-Cl-4-Br—Ph
2-Cl-4-CN—Ph
2-Cl-4-F—Ph
2-Cl-6-F—Ph
2-Cl-4-I—Ph
2-Cl-4-MeO—Ph
2-Cl-4-EtO—Ph
2-F-4-Br—Ph
2-F-4-Cl—Ph
2-F-4-CN—Ph
2-F-4-I—Ph
2-Br-4-F-6-Cl—Ph
2-Me-3-pyridinyl
3,5-di-F-2-pyridinyl
2-F-4-MeO—Ph
2-F-4-EtO—Ph
2-I-4-F—Ph
2-I-6-F—Ph
2-CF₃-4-F—Ph
2-CF₃-6-F—Ph
2-Me-4-F—Ph
2,4,6-tri-Cl—Ph
2,3,5-tri-F—Ph
2,3,6-tri-F—Ph
2,4,5-tri-F—Ph
2,4,6-tri-F—Ph
2,4-di-Br-6-F—Ph
2-Cl-4-Br-6-F—Ph
2,4-di-Cl-3-pyridinyl
2-Cl-6-MeO-3-pyridinyl
2,4-di-Cl-6-F—Ph
2,6-di-Cl-4-CN—Ph
2,6-di-Cl-4-F—Ph
2,6-di-Cl-4-MeO—Ph
2,6-di-F-4-Br—Ph
2,6-di-F-4-Cl—Ph
2,6-di-F-4-CN—Ph
2,6-di-F-4-I—Ph
2,6-di-F-4-MeO—Ph
2,6-di-F-4-EtO—Ph
2-Br-4,6-di-F—Ph
2-Cl-4,6-di-F—Ph
2-I-4,6-di-F—Ph
2-Br-3-pyridinyl
2,6-di-Cl-3-pyridinyl
2-Br-3-thienyl

The present disclosure also includes Tables 1A through 314A, each of which is constructed the same as Table 1 above, except that the row heading in Table 1 (i.e. “Q¹ is 4-F-Ph, R¹ is H, R² is Me”) is replaced with the respective row heading shown below. For Example, in Table 1A the row heading is “Q¹ is 4-F-Ph, R¹ is H, R² is Br”, and Q² is as defined in Table 1 above. Thus, the first entry in Table 1A specifically discloses 4-bromo-5-(2-bromophenyl)-N-(4-fluorophenyl)-1H-imidazol-1-amine. Tables 2A through 314A are constructed similarly.

| Table | Row Heading |
|---|---|
| 1A | Q¹ is 4-F—Ph, R¹ is H, R² is Br |
| 2A | Q¹ is 4-F—Ph, R¹ is H, R² is Cl |
| 3A | Q¹ is 4-F—Ph, R¹ is Br, R² is H |
| 4A | Q¹ is 4-F—Ph, R¹ is Br, R² is Br |
| 5A | Q¹ is 4-F—Ph, R¹ is Br, R² is Cl |
| 6A | Q¹ is 4-F—Ph, R¹ is Br, R² is Me |
| 7A | Q¹ is 4-F—Ph, R¹ is Cl, R² is H |
| 8A | Q¹ is 4-F—Ph, R¹ is Cl, R² is Br |
| 9A | Q¹ is 4-F—Ph, R¹ is Cl, R² is Cl |
| 10A | Q¹ is 4-F—Ph, R¹ is Cl, R² is Me |
| 11A | Q¹ is 4-F—Ph, R¹ is Me, R² is H |
| 12A | Q¹ is 4-F—Ph, R¹ is Me, R² is Br |
| 13A | Q¹ is 4-F—Ph, R¹ is Me, R² is Cl |
| 14A | Q¹ is 4-F—Ph, R¹ is Me, R² is Me |
| 15A | Q¹ is 2,4-di-F—Ph, R¹ is H, R² is Br |
| 16A | Q¹ is 2,4-di-F—Ph, R¹ is H, R² is Cl |
| 17A | Q¹ is 2,4-di-F—Ph, R¹ is H, R² is Me |
| 18A | Q¹ is 2,4-di-F—Ph, R¹ is Br, R² is H |
| 19A | Q¹ is 2,4-di-F—Ph, R¹ is Br, R² is Br |
| 20A | Q¹ is 2,4-di-F—Ph, R¹ is Br, R² is Cl |
| 21A | Q¹ is 2,4-di-F—Ph, R¹ is Br, R² is Me |
| 22A | Q¹ is 2,4-di-F—Ph, R¹ is Cl, R² is H |
| 23A | Q¹ is 2,4-di-F—Ph, R¹ is Cl, R² is Br |
| 24A | Q¹ is 2,4-di-F—Ph, R¹ is Cl, R² is Cl |
| 25A | Q¹ is 2,4-di-F—Ph, R¹ is Cl, R² is Me |
| 26A | Q¹ is 2,4-di-F—Ph, R¹ is Me, R² is H |
| 27A | Q¹ is 2,4-di-F—Ph, R¹ is Me, R² is Br |
| 28A | Q¹ is 2,4-di-F—Ph, R¹ is Me, R² is Cl |
| 29A | Q¹ is 2,4-di-F—Ph, R¹ is Me, R² is Me |
| 30A | Q¹ is 2-Cl-4-F—Ph, R¹ is H, R² is Br |
| 31A | Q¹ is 2-Cl-4-F—Ph, R¹ is H, R² is Cl |
| 32A | Q¹ is 2-Cl-4-F—Ph, R¹ is H, R² is Me |
| 33A | Q¹ is 2-Cl-4-F—Ph, R¹ is Br, R² is H |
| 34A | Q¹ is 2-Cl-4-F—Ph, R¹ is Br, R² is Br |
| 35A | Q¹ is 2-Cl-4-F—Ph, R¹ is Br, R² is Cl |
| 36A | Q¹ is 2-Cl-4-F—Ph, R¹ is Br, R² is Me |
| 37A | Q¹ is 2-Cl-4-F—Ph, R¹ is Cl, R² is H |
| 38A | Q¹ is 2-Cl-4-F—Ph, R¹ is Cl, R² is Br |
| 39A | Q¹ is 2-Cl-4-F—Ph, R¹ is Cl, R² is Cl |
| 40A | Q¹ is 2-Cl-4-F—Ph, R¹ is Cl, R² is Me |
| 41A | Q¹ is 2-Cl-4-F—Ph, R¹ is Me, R² is H |
| 42A | Q¹ is 2-Cl-4-F—Ph, R¹ is Me, R² is Br |
| 43A | Q¹ is 2-Cl-4-F—Ph, R¹ is Me, R² is Cl |
| 44A | Q¹ is 2-Cl-4-F—Ph, R¹ is Me, R² is Me |
| 45A | Q¹ is 2,4-di-Cl—Ph, R¹ is H, R² is Br |
| 46A | Q¹ is 2,4-di-Cl—Ph, R¹ is H, R² is Cl |
| 47A | Q¹ is 2,4-di-Cl—Ph, R¹ is H, R² is Me |
| 48A | Q¹ is 2,4-di-Cl—Ph, R¹ is Br, R² is H |
| 49A | Q¹ is 2,4-di-Cl—Ph, R¹ is Br, R² is Br |
| 50A | Q¹ is 2,4-di-Cl—Ph, R¹ is Br, R² is Cl |
| 51A | Q¹ is 2,4-di-Cl—Ph, R¹ is Br, R² is Me |
| 52A | Q¹ is 2,4-di-Cl—Ph, R¹ is Cl, R² is H |
| 53A | Q¹ is 2,4-di-Cl—Ph, R¹ is Cl, R² is Br |
| 54A | Q¹ is 2,4-di-Cl—Ph, R¹ is Cl, R² is Cl |
| 55A | Q¹ is 2,4-di-Cl—Ph, R¹ is Cl, R² is Me |
| 56A | Q¹ is 2,4-di-Cl—Ph, R¹ is Me, R² is H |
| 57A | Q¹ is 2,4-di-Cl—Ph, R¹ is Me, R² is Br |
| 58A | Q¹ is 2,4-di-Cl—Ph, R¹ is Me, R² is Cl |
| 59A | Q¹ is 2,4-di-Cl—Ph, R¹ is Me, R² is Me |
| 60A | Q¹ is 2-F-4-Cl—Ph, R¹ is H, R² is Br |
| 61A | Q¹ is 2-F-4-Cl—Ph, R¹ is H, R² is Cl |
| 62A | Q¹ is 2-F-4-Cl—Ph, R¹ is H, R² is Me |
| 63A | Q¹ is 2-F-4-Cl—Ph, R¹ is Br, R² is H |
| 64A | Q¹ is 2-F-4-Cl—Ph, R¹ is Br, R² is Br |
| 65A | Q¹ is 2-F-4-Cl—Ph, R¹ is Br, R² is Cl |
| 66A | Q¹ is 2-F-4-Cl—Ph, R¹ is Br, R² is Me |
| 67A | Q¹ is 2-F-4-Cl—Ph, R¹ is Cl, R² is H |
| 68A | Q¹ is 2-F-4-Cl—Ph, R¹ is Cl, R² is Br |
| 69A | Q¹ is 2-F-4-Cl—Ph, R¹ is Cl, R² is Cl |
| 70A | Q¹ is 2-F-4-Cl—Ph, R¹ is Cl, R² is Me |
| 71A | Q¹ is 2-F-4-Cl—Ph, R¹ is Me, R² is H |
| 72A | Q¹ is 2-F-4-Cl—Ph, R¹ is Me, R² is Br |
| 73A | Q¹ is 2-F-4-Cl—Ph, R¹ is Me, R² is Cl |
| 74A | Q¹ is 2-F-4-Cl—Ph, R¹ is Me, R² is Me |
| 75A | Q¹ is 2-Br-4-F—Ph, R¹ is H, R² is Br |
| 76A | Q¹ is 2-Br-4-F—Ph, R¹ is H, R² is Cl |
| 77A | Q¹ is 2-Br-4-F—Ph, R¹ is H, R² is Me |
| 78A | Q¹ is 2-Br-4-F—Ph, R¹ is Br, R² is H |
| 79A | Q¹ is 2-Br-4-F—Ph, R¹ is Br, R² is Br |
| 80A | Q¹ is 2-Br-4-F—Ph, R¹ is Br, R² is Cl |
| 81A | Q¹ is 2-Br-4-F—Ph, R¹ is Br, R² is Me |
| 82A | Q¹ is 2-Br-4-F—Ph, R¹ is Cl, R² is H |
| 83A | Q¹ is 2-Br-4-F—Ph, R¹ is Cl, R² is Br |
| 84A | Q¹ is 2-Br-4-F—Ph, R¹ is Cl, R² is Cl |
| 85A | Q¹ is 2-Br-4-F—Ph, R¹ is Cl, R² is Me |
| 86A | Q¹ is 2-Br-4-F—Ph, R¹ is Me, R² is H |
| 87A | Q¹ is 2-Br-4-F—Ph, R¹ is Me, R² is Br |
| 88A | Q¹ is 2-Br-4-F—Ph, R¹ is Me, R² is Cl |
| 89A | Q¹ is 2-Br-4-F—Ph, R¹ is Me, R² is Me |
| 90A | Q¹ is 2-Me-4-F—Ph, R¹ is H, R² is Br |
| 91A | Q¹ is 2-Me-4-F—Ph, R¹ is H, R² is Cl |
| 92A | Q¹ is 2-Me-4-F—Ph, R¹ is H, R² is Me |
| 93A | Q¹ is 2-Me-4-F—Ph, R¹ is Br, R² is H |
| 94A | Q¹ is 2-Me-4-F—Ph, R¹ is Br, R² is Br |
| 95A | Q¹ is 2-Me-4-F—Ph, R¹ is Br, R² is Cl |
| 96A | Q¹ is 2-Me-4-F—Ph, R¹ is Br, R² is Me |
| 97A | Q¹ is 2-Me-4-F—Ph, R¹ is Cl, R² is H |
| 98A | Q¹ is 2-Me-4-F—Ph, R¹ is Cl, R² is Br |
| 99A | Q¹ is 2-Me-4-F—Ph, R¹ is Cl, R² is Cl |
| 100A | Q¹ is 2-Me-4-F—Ph, R¹ is Cl, R² is Me |
| 101A | Q¹ is 2-Me-4-F—Ph, R¹ is Me, R² is H |
| 102A | Q¹ is 2-Me-4-F—Ph, R¹ is Me, R² is Br |
| 103A | Q¹ is 2-Me-4-F—Ph, R¹ is Me, R² is Cl |
| 104A | Q¹ is 2-Me-4-F—Ph, R¹ is Me, R² is Me |
| 105A | Q¹ is 2,4,6-tri-F—Ph, R¹ is H, R² is Br |
| 106A | Q¹ is 2,4,6-tri-F—Ph, R¹ is H, R² is Cl |
| 107A | Q¹ is 2,4,6-tri-F—Ph, R¹ is H, R² is Me |
| 108A | Q¹ is 2,4,6-tri-F—Ph, R¹ is Br, R² is H |
| 109A | Q¹ is 2,4,6-tri-F—Ph, R¹ is Br, R² is Br |
| 110A | Q¹ is 2,4,6-tri-F—Ph, R¹ is Br, R² is Cl |
| 111A | Q¹ is 2,4,6-tri-F—Ph, R¹ is Br, R² is Me |
| 112A | Q¹ is 2,4,6-tri-F—Ph, R¹ is Cl, R² is H |
| 113A | Q¹ is 2,4,6-tri-F—Ph, R¹ is Cl, R² is Br |
| 114A | Q¹ is 2,4,6-tri-F—Ph, R¹ is Cl, R² is Cl |
| 115A | Q¹ is 2,4,6-tri-F—Ph, R¹ is Cl, R² is Me |
| 116A | Q¹ is 2,4,6-tri-F—Ph, R¹ is Me, R² is H |
| 117A | Q¹ is 2,4,6-tri-F—Ph, R¹ is Me, R² is Br |
| 118A | Q¹ is 2,4,6-tri-F—Ph, R¹ is Me, R² is Cl |
| 119A | Q¹ is 2,4,6-tri-F—Ph, R¹ is Me, R² is Me |
| 120A | Q¹ is 2,6-di-F-4-CN—Ph, R¹ is H, R² is Br |
| 121A | Q¹ is 2,6-di-F-4-CN—Ph, R¹ is H, R² is Cl |
| 122A | Q¹ is 2,6-di-F-4-CN—Ph, R¹ is H, R² is Me |
| 123A | Q¹ is 2,6-di-F-4-CN—Ph, R¹ is Br, R² is H |
| 124A | Q¹ is 2,6-diF-4-CN—Ph, R¹ is Br, R² is Br |
| 125A | Q¹ is 2,6-di-F-4-CN—Ph, R¹ is Br, R² is Cl |
| 126A | Q¹ is 2,6-di-F-4-CN—Ph, R¹ is Br, R² is Me |
| 127A | Q¹ is 2,6-di-F-4-CN—Ph, R¹ is Cl, R² is H |
| 128A | Q¹ is 2,6-di-F-4-CN—Ph, R¹ is Cl, R² is Br |
| 129A | Q¹ is 2,6-di-F-4-CN—Ph, R¹ is Cl, R² is Cl |
| 130A | Q¹ is 2,6-di-F-4-CN—Ph, R¹ is Cl, R² is Me |
| 131A | Q¹ is 2,6-di-F-4-CN—Ph, R¹ is Me, R² is H |
| 132A | Q¹ is 2,6-di-F-4-CN—Ph, R¹ is Me, R² is Br |
| 133A | Q¹ is 2,6-di-F-4-CN—Ph, R¹ is Me, R² is Cl |
| 134A | Q¹ is 2,6-di-F-4-CN—Ph, R¹ is Me, R² is Me |
| 135A | Q¹ is 2,6-di-F—Ph, R¹ is H, R² is Br |
| 136A | Q¹ is 2,6-di-F—Ph, R¹ is H, R² is Cl |
| 137A | Q¹ is 2,6-di-F—Ph, R¹ is H, R² is Me |
| 138A | Q¹ is 2,6-di-F—Ph, R¹ is Br, R² is H |
| 139A | Q¹ is 2,6-di-F—Ph, R¹ is Br, R² is Br |
| 140A | Q¹ is 2,6-di-F—Ph, R¹ is Br, R² is Cl |
| 141A | Q¹ is 2,6-di-F—Ph, R¹ is Br, R² is Me |
| 142A | Q¹ is 2,6-di-F—Ph, R¹ is Cl, R² is H |
| 143A | Q¹ is 2,6-di-F—Ph, R¹ is Cl, R² is Br |
| 144A | Q¹ is 2,6-di-F—Ph, R¹ is Cl, R² is Cl |
| 145A | Q¹ is 2,6-di-F—Ph, R¹ is Cl, R² is Me |
| 146A | Q¹ is 2,6-di-F—Ph, R¹ is Me, R² is H |
| 147A | Q¹ is 2,6-di-F—Ph, R¹ is Me, R² is Br |
| 148A | Q¹ is 2,6-di-F—Ph, R¹ is Me, R² is Cl |
| 149A | Q¹ is 2,6-di-F—Ph, R¹ is Me, R² is Me |
| 150A | Q¹ is 2,4,6-tri-Cl—Ph, R¹ is H, R² is Br |
| 151A | Q¹ is 2,4,6-tri-Cl—Ph, R¹ is H, R² is Cl |
| 152A | Q¹ is 2,4,6-tri-Cl—Ph, R¹ is H, R² is Me |
| 153A | Q¹ is 2,4,6-tri-Cl—Ph, R¹ is Br, R² is H |
| 154A | Q¹ is 2,4,6-tri-Cl—Ph, R¹ is Br, R² is Br |
| 155A | Q¹ is 2,4,6-tri-Cl—Ph, R¹ is Br, R² is Cl |
| 156A | Q¹ is 2,4,6-tri-Cl—Ph, R¹ is Br, R² is Me |
| 157A | Q¹ is 2,4,6-tri-Cl—Ph, R¹ is Cl, R² is H |
| 158A | Q¹ is 2,4,6-tri-Cl—Ph, R¹ is Cl, R² is Br |
| 159A | Q¹ is 2,4,6-tri-Cl—Ph, R¹ is Cl, R² is Cl |
| 160A | Q¹ is 2,4,6-tri-Cl—Ph, R¹ is Cl, R² is Me |
| 161A | Q¹ is 2,4,6-tri-Cl—Ph, R¹ is Me, R² is H |
| 162A | Q¹ is 2,4,6-tri-Cl—Ph, R¹ is Me, R² is Br |
| 163A | Q¹ is 2,4,6-tri-Cl—Ph, R¹ is Me, R² is Cl |
| 164A | Q¹ is 2,4,6-tri-Cl—Ph, R¹ is Me, R² is Me |
| 165A | Q¹ is 2-Cl-4,6-di-F—Ph, R¹ is H, R² is Br |
| 166A | Q¹ is 2-Cl-4,6-di-F—Ph, R¹ is H, R² is Cl |
| 167A | Q¹ is 2-Cl-4,6-di-F—Ph, R¹ is H, R² is Me |
| 168A | Q¹ is 2-Cl-4,6-di-F—Ph, R¹ is Br, R² is H |
| 169A | Q¹ is 2-Cl-4,6-di-F—Ph, R¹ is Br, R² is Br |
| 170A | Q¹ is 2-Cl-4,6-di-F—Ph, R¹ is Br, R² is Cl |
| 171A | Q¹ is 2-Cl-4,6-di-F—Ph, R¹ is Br, R² is Me |
| 172A | Q¹ is 2-Cl-4,6-di-F—Ph, R¹ is Cl, R² is H |
| 173A | Q¹ is 2-Cl-4,6-di-F—Ph, R¹ is Cl, R² is Br |
| 174A | Q¹ is 2-Cl-4,6-di-F—Ph, R¹ is Cl, R² is Cl |
| 175A | Q¹ is 2-Cl-4,6-di-F—Ph, R¹ is Cl, R² is Me |
| 176A | Q¹ is 2-Cl-4,6-di-F—Ph, R¹ is Me, R² is H |
| 177A | Q¹ is 2-Cl-4,6-di-F—Ph, R¹ is Me, R² is Br |
| 178A | Q¹ is 2-Cl-4,6-di-F—Ph, R¹ is Me, R² is Cl |
| 179A | Q¹ is 2-Cl-4,6-di-F—Ph, R¹ is Me, R² is Me |
| 180A | Q¹is 2,4-di-Cl-6-F—Ph, R¹ is H, R² is Br |
| 181A | Q¹is 2,4-di-Cl-6-F—Ph, R¹ is H, R² is Cl |
| 182A | Q¹is 2,4-di-Cl-6-F—Ph, R¹ is H, R² is Me |
| 183A | Q¹is 2,4-di-Cl-6-F—Ph, R¹ is Br, R² is H |
| 184A | Q¹is 2,4-di-Cl-6-F—Ph, R¹ is Br, R² is Br |
| 185A | Q¹is 2,4-di-Cl-6-F—Ph, R¹ is Br, R² is Cl |
| 186A | Q¹is 2,4-di-Cl-6-F—Ph, R¹ is Br, R² is Me |
| 187A | Q¹is 2,4-di-Cl-6-F—Ph, R¹ is Cl, R² is H |
| 188A | Q¹is 2,4-di-Cl-6-F—Ph, R¹ is Cl, R² is Br |
| 189A | Q¹is 2,4-di-Cl-6-F—Ph, R¹ is Cl, R² is Cl |
| 190A | Q¹is 2,4-di-Cl-6-F—Ph, R¹ is Cl, R² is Me |
| 191A | Q¹is 2,4-di-Cl-6-F—Ph, R¹ is Me, R² is H |
| 192A | Q¹is 2,4-di-Cl-6-F—Ph, R¹ is Me, R² is Br |
| 193A | Q¹is 2,4-di-Cl-6-F—Ph, R¹ is Me, R² is Cl |
| 194A | Q¹is 2,4-di-Cl-6-F—Ph, R¹ is Me, R² is Me |
| 195A | Q¹ is 2-Br-4,6-di-F—Ph, R¹ is H, R² is Br |
| 196A | Q¹ is 2-Br-4,6-di-F—Ph, R¹ is H, R² is Cl |
| 197A | Q¹ is 2-Br-4,6-di-F—Ph, R¹ is H, R² is Me |
| 198A | Q¹ is 2-Br-4,6-di-F—Ph, R¹ is Br, R² is H |
| 199A | Q¹ is 2-Br-4,6-di-F—Ph, R¹ is Br, R² is Br |
| 200A | Q¹ is 2-Br-4,6-di-F—Ph, R¹ is Br, R² is Cl |
| 201A | Q¹ is 2-Br-4,6-di-F—Ph, R¹ is Br, R² is Me |
| 202A | Q¹ is 2-Br-4,6-di-F—Ph, R¹ is Cl, R² is H |
| 203A | Q¹ is 2-Br-4,6-di-F—Ph, R¹ is Cl, R² is Br |
| 204A | Q¹ is 2-Br-4,6-di-F—Ph, R¹ is Cl, R² is Cl |
| 205A | Q¹ is 2-Br-4,6-di-F—Ph, R¹ is Cl, R² is Me |
| 206A | Q¹ is 2-Br-4,6-di-F—Ph, R¹ is Me, R² is H |
| 207A | Q¹ is 2-Br-4,6-di-F—Ph, R¹ is Me, R² is Br |
| 208A | Q¹ is 2-Br-4,6-di-F—Ph, R¹ is Me, R² is Cl |
| 209A | Q¹ is 2-Br-4,6-di-F—Ph, R¹ is Me, R² is Me |
| 210A | Q¹ is 2-Br-4,6-di-Cl—Ph, R¹ is H, R² is Br |
| 211A | Q¹ is 2-Br-4,6-di-Cl—Ph, R¹ is H, R² is Cl |
| 212A | Q¹ is 2-Br-4,6-di-Cl—Ph, R¹ is H, R² is Me |
| 213A | Q¹ is 2-Br-4,6-di-Cl—Ph, R¹ is Br, R² is H |
| 214A | Q¹ is 2-Br-4,6-di-Cl—Ph, R¹ is Br, R² is Br |
| 215A | Q¹ is 2-Br-4,6-di-Cl—Ph, R¹ is Br, R² is Cl |
| 216A | Q¹ is 2-Br-4,6-di-Cl—Ph, R¹ is Br, R² is Me |
| 217A | Q¹ is 2-Br-4,6-di-Cl—Ph, R¹ is Cl, R² is H |
| 218A | Q¹ is 2-Br-4,6-di-Cl—Ph, R¹ is Cl, R² is Br |
| 219A | Q¹ is 2-Br-4,6-di-Cl—Ph, R¹ is Cl, R² is Cl |
| 220A | Q¹ is 2-Br-4,6-di-Cl—Ph, R¹ is Cl, R² is Me |
| 221A | Q¹ is 2-Br-4,6-di-Cl—Ph, R¹ is Me, R² is H |
| 222A | Q¹ is 2-Br-4,6-di-Cl—Ph, R¹ is Me, R² is Br |
| 223A | Q¹ is 2-Br-4,6-di-Cl—Ph, R¹ is Me, R² is Cl |
| 224A | Q¹ is 2-Br-4,6-di-Cl—Ph, R¹ is Me, R² is Me |
| 225A | Q¹ is 2-F-4-MeO—Ph, R¹ is H, R² is Br |
| 226A | Q¹ is 2-F-4-MeO—Ph, R¹ is H, R² is Cl |
| 227A | Q¹ is 2-F-4-MeO—Ph, R¹ is H, R² is Me |
| 228A | Q¹ is 2-F-4-MeO—Ph, R¹ is Br, R² is H |
| 229A | Q¹ is 2-F-4-MeO—Ph, R¹ is Br, R² is Br |
| 230A | Q¹ is 2-F-4-MeO—Ph, R¹ is Br, R² is Cl |
| 231A | Q¹ is 2-F-4-MeO—Ph, R¹ is Br, R² is Me |
| 232A | Q¹ is 2-F-4-MeO—Ph, R¹ is Cl, R² is H |
| 233A | Q¹ is 2-F-4-MeO—Ph, R¹ is Cl, R² is Br |
| 234A | Q¹ is 2-F-4-MeO—Ph, R¹ is Cl, R² is Cl |
| 236A | Q¹ is 2-F-4-MeO—Ph, R¹ is Cl, R² is Me |
| 237A | Q¹ is 2-F-4-MeO—Ph, R¹ is Me, R² is H |
| 238A | Q¹ is 2-F-4-MeO—Ph, R¹ is Me, R² is Br |
| 239A | Q¹ is 2-F-4-MeO—Ph, R¹ is Me, R² is Cl |
| 240A | Q¹ is 2-F-4-MeO—Ph, R¹ is Me, R² is Me |
| 241A | Q¹ is 2-Cl-4-MeO—Ph, R¹ is H, R² is Br |
| 242A | Q¹ is 2-Cl-4-MeO—Ph, R¹ is H, R² is Cl |
| 243A | Q¹ is 2-Cl-4-MeO—Ph, R¹ is H, R² is Me |
| 244A | Q¹ is 2-Cl-4-MeO—Ph, R¹ is Br, R² is H |
| 245A | Q¹ is 2-Cl-4-MeO—Ph, R¹ is Br, R² is Br |
| 246A | Q¹ is 2-Cl-4-MeO—Ph, R¹ is Br, R² is Cl |
| 247A | Q¹ is 2-Cl-4-MeO—Ph, R¹ is Br, R² is Me |
| 248A | Q¹ is 2-Cl-4-MeO—Ph, R¹ is Cl, R² is H |
| 249A | Q¹ is 2-Cl-4-MeO—Ph, R¹ is Cl, R² is Br |
| 250A | Q¹ is 2-Cl-4-MeO—Ph, R¹ is Cl, R² is Cl |
| 251A | Q¹ is 2-Cl-4-MeO—Ph, R¹ is Cl, R² is Me |
| 252A | Q¹ is 2-Cl-4-MeO—Ph, R¹ is Me, R² is H |
| 253A | Q¹ is 2-Cl-4-MeO—Ph, R¹ is Me, R² is Br |
| 254A | Q¹ is 2-Cl-4-MeO—Ph, R¹ is Me, R² is Cl |
| 255A | Q¹ is 2-Cl-4-MeO—Ph, R¹ is Me, R² is Me |
| 246A | Q¹ is 2-F-4-CN—Ph, R¹ is H, R² is Br |
| 256A | Q¹ is 2-F-4-CN—Ph, R¹ is H, R² is Cl |
| 257A | Q¹ is 2-F-4-CN—Ph, R¹ is H, R² is Me |
| 258A | Q¹ is 2-F-4-CN—Ph, R¹ is Br, R² is H |
| 259A | Q¹ is 2-F-4-CN—Ph, R¹ is Br, R² is Br |
| 260A | Q¹ is 2-F-4-CN—Ph, R¹ is Br, R² is Cl |
| 261A | Q¹ is 2-F-4-CN—Ph, R¹ is Br, R² is Me |
| 262A | Q¹ is 2-F-4-CN—Ph, R¹ is Cl, R² is H |
| 263A | Q¹ is 2-F-4-CN—Ph, R¹ is Cl, R² is Br |
| 264A | Q¹ is 2-F-4-CN—Ph, R¹ is Cl, R² is Cl |
| 265A | Q¹ is 2-F-4-CN—Ph, R¹ is Cl, R² is Me |
| 266A | Q¹ is 2-F-4-CN—Ph, R¹ is Me, R² is H |
| 267A | Q¹ is 2-F-4-CN—Ph, R¹ is Me, R² is Br |
| 268A | Q¹ is 2-F-4-CN—Ph, R¹ is Me, R² is Cl |
| 269A | Q¹ is 2-F-4-CN—Ph, R¹ is Me, R² is Me |
| 270A | Q¹ is 2-Cl-4-CN—Ph, R¹ is H, R² is Br |
| 271A | Q¹ is 2-Cl-4-CN—Ph, R¹ is H, R² is Cl |
| 272A | Q¹ is 2-Cl-4-CN—Ph, R¹ is H, R² is Me |
| 273A | Q¹ is 2-Cl-4-CN—Ph, R¹ is Br, R² is H |
| 274A | Q¹ is 2-Cl-4-CN—Ph, R¹ is Br, R² is Br |
| 275A | Q¹ is 2-Cl-4-CN—Ph, R¹ is Br, R² is Cl |
| 276A | Q¹ is 2-Cl-4-CN—Ph, R¹ is Br, R² is Me |
| 277A | Q¹ is 2-Cl-4-CN—Ph, R¹ is Cl, R² is H |
| 278A | Q¹ is 2-Cl-4-CN—Ph, R¹ is Cl, R² is Br |
| 279A | Q¹ is 2-Cl-4-CN—Ph, R¹ is Cl, R² is Cl |
| 280A | Q¹ is 2-Cl-4-CN—Ph, R¹ is Cl, R² is Me |
| 281A | Q¹ is 2-Cl-4-CN—Ph, R¹ is Me, R² is H |
| 282A | Q¹ is 2-Cl-4-CN—Ph, R¹ is Me, R² is Br |
| 283A | Q¹ is 2-Cl-4-CN—Ph, R¹ is Me, R² is Cl |
| 284A | Q¹ is 2-Cl-4-CN—Ph, R¹ is Me, R² is Me |
| 285A | Q¹ is 4-Cl—Ph, R¹ is H, R² is Br |
| 286A | Q¹ is 4-Cl—Ph, R¹ is H, R² is Cl |
| 287A | Q¹ is 4-Cl—Ph, R¹ is H, R² is Me |
| 288A | Q¹ is 4-Cl—Ph, R¹ is Br, R² is H |
| 289A | Q¹ is 4-Cl—Ph, R¹ is Br, R² is Br |
| 290A | Q¹ is 4-Cl—Ph, R¹ is Br, R² is Cl |
| 291A | Q¹ is 4-Cl—Ph, R¹ is Br, R² is Me |
| 292A | Q¹ is 4-Cl—Ph, R¹ is Cl, R² is H |
| 293A | Q¹ is 4-Cl—Ph, R¹ is Cl, R² is Br |
| 294A | Q¹ is 4-Cl—Ph, R¹ is Cl, R² is Cl |
| 295A | Q¹ is 4-Cl—Ph, R¹ is Cl, R² is Me |
| 296A | Q¹ is 4-Cl—Ph, R¹ is Me, R² is H |
| 297A | Q¹ is 4-Cl—Ph, R¹ is Me, R² is Br |
| 298A | Q¹ is 4-Cl—Ph, R¹ is Me, R² is Cl |
| 299A | Q¹ is 4-Cl—Ph, R¹ is Me, R² is Me |
| 300A | Q¹ is 6-Cl-3-pyridinyl, R¹ is H, R² is Br |
| 301A | Q¹ is 6-Cl-3-pyridinyl, R¹ is H, R² is Cl |
| 302A | Q¹ is 6-Cl-3-pyridinyl, R¹ is H, R² is Me |
| 303A | Q¹ is 6-Cl-3-pyridinyl, R¹ is Br, R² is H |
| 304A | Q¹ is 6-Cl-3-pyridinyl, R¹ is Br, R² is Br |
| 305A | Q¹ is 6-Cl-3-pyridinyl, R¹ is Br, R² is Cl |
| 306A | Q¹ is 6-Cl-3-pyridinyl, R¹ is Br, R² is Me |
| 307A | Q¹ is 6-Cl-3-pyridinyl, R¹ is Cl, R² is H |
| 308A | Q¹ is 6-Cl-3-pyridinyl, R¹ is Cl, R² is Br |
| 309A | Q¹ is 6-Cl-3-pyridinyl, R¹ is Cl, R² is Cl |
| 310A | Q¹ is 6-Cl-3-pyridinyl, R¹ is Cl, R² is Me |
| 311A | Q¹ is 6-Cl-3-pyridinyl, R¹ is Me, R² is H |
| 312A | Q¹ is 6-Cl-3-pyridinyl, R¹ is Me, R² is Br |
| 313A | Q¹ is 6-Cl-3-pyridinyl, R¹ is Me, R² is Cl |
| 314A | Q¹ is 6-Cl-3-pyridinyl, R¹ is Me, R² is Me |

TABLE 2

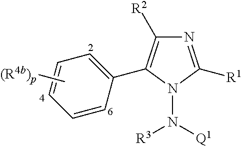

| Q¹ | R¹ | R² | (R^{4b})ₚ | R³ |
|---|---|---|---|---|
| 2,4-di-F—Ph | Me | Me | H | Me |
| 2-Cl-4-F—Ph | Me | Me | 2-Cl | methoxymethyl |
| 2-Me-4-F—Ph | Me | Me | 2-Br | formyl |
| 2-Cl-4-F—Ph | Me | Br | H | acetyl |
| 2,4-di-F—Ph | Me | Br | 2-Cl | trifluoroacetyl |
| 2-Cl-4-F—Ph | Me | Br | 2-Br | hydroxyl |
| 2-Cl-4-F—Ph | Me | Cl | H | methoxy |
| 2-Me-4-F—Ph | Me | Cl | 2-Cl | methylthio |
| 2,4-di-F—Ph | Me | Cl | 2-Br | methylsulfinyl |
| 2,4-di-F—Ph | Br | Br | H | methylsulfonyl |
| 2-Cl-4-F—Ph | Br | Cl | 2-Cl | trifluoromethylsulfonyl |
| 2-Me-4-F—Ph | Br | Me | 2-Br | methylthiomethyl |
| 2,4-di-F—Ph | Cl | Br | H | c-propyl |
| 2-Cl-4-F—Ph | Cl | Cl | 2-Cl | cyanomethyl |
| 2-Cl-4-F—Ph | Cl | Me | 2-Br | methoxycarbonyl |

### Formulation/Utility

A compound of Formula 1 of this invention (including N-oxides and salts thereof) will generally be used as a fungicidal active ingredient in a composition, i.e. formulation, with at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-95 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compound of Formula 1 and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Index Table A. Without further elaboration, it is believed that one skilled in the art using the preceding description can utilize the present invention to its fullest extent. The following Examples are, therefore, to be constructed as merely illustrative, and not limiting of the disclosure in any way whatsoever. Percentages are by weight except where otherwise indicated.

### Example A

### High Strength Concentrate

| | |
|---|---|
| Compound 1 | 98.5% |
| silica aerogel | 0.5% |
| synthetic amorphous fine silica | 1.0% |

### Example B

### Wettable Powder

| | |
|---|---|
| Compound 7 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### Example C

### Granule

| | |
|---|---|
| Compound 8 | 10.0% |
| attapulgite granules (low volatile matter, 0.71/0.30 mm; | 90.0% |
| U.S.S. No. 25-50 sieves) | |

### Example D

### Extruded Pellet

| | |
|---|---|
| Compound 7 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### Example E

### Emulsifiable Concentrate

| | |
|---|---|
| Compound 8 | 10.0% |
| polyoxyethylene sorbitol hexoleate | 20.0% |
| C₆-C₁₀ fatty acid methyl ester | 70.0% |

### Example F

### Microemulsion

| | |
|---|---|
| Compound 1 | 5.0% |
| polyvinylpyrrolidone-vinyl acetate copolymer | 30.0% |
| alkylpolyglycoside | 30.0% |
| glyceryl monooleate | 15.0% |
| water | 20.0% |

### Example G

### Seed Treatment

| | |
|---|---|
| Compound 2 | 20.00% |
| polyvinylpyrrolidone-vinyl acetate copolymer | 5.00% |
| montan acid wax | 5.00% |
| calcium ligninsulfonate | 1.00% |
| polyoxyethylene/polyoxypropylene block copolymers | 1.00% |
| stearyl alcohol (POE 20) | 2.00% |
| polyorganosilane | 0.20% |
| colorant red dye | 0.05% |
| water | 65.75% |

Water-soluble and water-dispersible formulations are typically diluted with water to form aqueous compositions before application. Aqueous compositions for direct applications to the plant or portion thereof (e.g., spray tank compositions) typically at least about 1 ppm or more (e.g., from 1 ppm to 100 ppm) of the compound(s) of this invention.

The compounds of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound. The compounds and/or compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, turf, vegetable, field, cereal, and fruit crops. These pathogens include: Oomycetes, including Phytophthora diseases such as Phytophthora infestans, Phytophthora megasperma, Phytophthora parasitica, Phytophthora cinnamomi and Phytophthora capsici, Pythium diseases such as Pythium aphanidermatum, and diseases in the Peronosporaceae family such as Plasmopara viticola, Peronospora spp. (including Peronospora tabacina and Peronospora parasitica), Pseudoperonospora spp. (including Pseudoperonospora cubensis) and Bremia lactucae; Ascomycetes, including Alternaria diseases such as Alternaria solani and Alternaria brassicae, Guignardia diseases such as Guignardia bidwell, Venturia diseases such as Venturia inaequalis, Septoria diseases such as Septoria nodorum and Septoria tritici, powdery mildew diseases such as Erysiphe spp. (including Erysiphe graminis and Erysiphe polygoni), Uncinula necatur, Sphaerotheca fuliginea, Podosphaera leucotricha and Pseudocercosporella herpotrichoides, Botrytis diseases such as Botrytis cinerea, Monilinia fructicola, Sclerotinia diseases such as Sclerotinia sclerotiorum, Sclerotinia minor, Magnaporthe grisea, and Phomopsis viticola, Helminthosporium diseases such as Helminthosporium tritici repentis and Pyrenophora teres, anthracnose diseases such as Glomerella or Colletotrichum spp. (such as Colletotrichum graminicola and Colletotrichum orbiculare), and Gaeumannomyces graminis; Basidiomycetes, including rust diseases caused by Puccinia spp. (such as Puccinia recondite, Puccinia striiformis, Puccinia hordei, Puccinia graminis and Puccinia arachidis), Hemileia vastatrix and Phakopsora pachyrhizi; other pathogens including Rutstroemia floccosum (also known as Sclerotinia homoeocarpa); Rhizoctonia spp. (such as Rhizoctonia solani); Fusarium diseases such as Fusarium roseum, Fusarium graminearum and Fusarium oxysporum Verticillium dahliae; Sclerotium rolfsii; Rynchosporium secalis; Cercosporidium personatum, Cercospora arachidicola and Cercospora beticola; Rhizopus spp. (such as Rhizopus stolonifer); Aspergillus spp. (such as Aspergillus flavus and Aspergillus parasiticus); and other genera and species closely related to these pathogens. In addition to their fungicidal activity, the compositions or combinations also have activity against bacteria such as Erwinia amylovora, Xanthomonas campestris, Pseudomonas syringae, and other related species. Furthermore, the compounds of this invention are useful in treating postharvest diseases of fruits and vegetables caused by fungi and bacteria. These infections can occur before, during and after harvest. For example, infections can occur before harvest and then remain dormant until some point during ripening (e.g., host begins tissue changes in such a way that infection can progress); also infections can arise from surface wounds created by mechanical or insect injury. In this respect, the compounds of this invention can reduce losses (i.e. losses resulting from quantity and quality) due to postharvest diseases which may occur at any time from harvest to consumption. Treatment of postharvest diseases with compounds of the invention can increase the period of time during which perishable edible plant parts (e.g, fruits, seeds, foliage, stems, bulbs. tubers) can be stored refrigerated or un-refrigerated after harvest, and remain edible and free from noticeable or harmful degradation or contamination by fungi or other microorganisms. Treatment of edible plant parts before or after harvest with compounds of the invention can also decrease the formation of toxic metabolites of fungi or other microorganisms, for example, mycotoxins such as aflatoxins.

Plant disease control is ordinarily accomplished by applying an effective amount of a compound of this invention either pre- or post-infection, to the portion of the plant to be protected such as the roots, stems, foliage, fruits, seeds, tubers or bulbs, or to the media (soil or sand) in which the plants to be protected are growing. The compounds can also be applied to seeds to protect the seeds and seedlings developing from the seeds. The compounds can also be applied through irrigation water to treat plants. Control of postharvest pathogens which infect the produce before harvest is typically accomplished by field application of a compound of this invention, and in cases where infection occurs after harvest the compounds can be applied to the harvested crop as dips, sprays, fumigants, treated wraps and box liners.

Rates of application for these compounds (i.e. a fungicidally effective amount) can be influenced by factors such as the plant diseases to be controlled, the plant species to be protected, ambient moisture and temperature and should be determined under actual use conditions. One skilled in the art can easily determine through simple experimentation the fungicidally effective amount necessary for the desired level of plant disease control. Foliage can normally be protected when treated at a rate of from less than about 1 g/ha to about 5,000 g/ha of active ingredient. Seed and seedlings can normally be protected when seed is treated at a rate of from about 0.1 to about 10 g per kilogram of seed.

Compounds of this invention can also be mixed with one or more other biologically active compounds or agents including fungicides, insecticides, nematocides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising a compound of Formula 1 (in a fungicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with a compound of Formula 1, to form a premix, or one or more other biologically active compounds or agents can be formulated separately from the compound of Formula 1, and the formulations combined together before application (e.g., in a spray tank) or, alternatively, applied in succession.

Of note is a composition which in addition to the compound of Formula 1 include at least one fungicidal compound selected from the group consisting of the classes (1) methyl benzimidazole carbamate (MBC) fungicides; (2) dicarboximide fungicides; (3) demethylation inhibitor (DMI) fungicides; (4) phenylamide fungicides; (5) amine/morpholine fungicides; (6) phospholipid biosynthesis inhibitor fungicides; (7) carboxamide fungicides; (8) hydroxy(2-amino-)pyrimidine fungicides; (9) anilinopyrimidine fungicides; (10) N-phenyl carbamate fungicides; (11) quinone outside inhibitor (QoI) fungicides; (12) phenylpyrrole fungicides; (13) quinoline fungicides; (14) lipid peroxidation inhibitor fungicides; (15) melanin biosynthesis inhibitors-reductase (MBI-R) fungicides; (16) melanin biosynthesis inhibitors-dehydratase (MBI-D) fungicides; (17) hydroxyanilide fungicides; (18) squalene-epoxidase inhibitor fungicides; (19) polyoxin fungicides; (20) phenylurea fungicides; (21) quinone inside inhibitor (QiI) fungicides; (22) benzamide fungicides; (23) enopyranuronic acid antibiotic fungicides; (24) hexopyranosyl antibiotic fungicides; (25) glucopyranosyl antibiotic: protein synthesis fungicides; (26) glucopyranosyl antibiotic: trehalase and inositol biosynthesis fungicides; (27) cyanoacetamideoxime fungicides; (28) carbamate fungicides; (29) oxidative phosphorylation uncoupling fungicides; (30) organo tin fungicides; (31) carboxylic acid fungicides; (32) heteroaromatic fungicides; (33) phosphonate fungicides; (34) phthalamic acid fungicides; (35) benzotriazine fungicides; (36) benzene-sulfonamide fungicides; (37) pyridazinone fungicides; (38) thiophene-carboxamide fungicides; (39) pyrimidinamide fungicides; (40) carboxylic acid amide (CAA) fungicides; (41) tetracycline antibiotic fungicides; (42) thiocarbamate fungicides; (43) benzamide fungicides; (44) host plant defense induction fungicides; (45) multi-site contact activity fungicides; (46) fungicides other than classes (1) through (45); and salts of compounds of classes (1) through (46).

Further descriptions of these classes of fungicidal compounds are provided below.

(1) “Methyl benzimidazole carbamate (MBC) fungicides” (Fungicide Resistance Action Committee (FRAC) code 1) inhibit mitosis by binding to β-tubulin during microtubule assembly. Inhibition of microtubule assembly can disrupt cell division, transport within the cell and cell structure. Methyl benzimidazole carbamate fungicides include benzimidazoles and thiophanates. The benzimidazoles include benomyl, carbendazim, fuberidazole and thiabendazole. The thiophanates include thiophanate and thiophanate-methyl.

(2) “Dicarboximide fungicides” (Fungicide Resistance Action Committee (FRAC) code 2) are proposed to inhibit a lipid peroxidation in fungi through interference with NADH cytochrome c reductase. Examples include chlozolinate, iprodione, procymidone and vinclozolin.

(3) “Demethylation inhibitor (DMI) fungicides” (Fungicide Resistance Action Committee (FRAC) code 3) inhibit C14-demethylase, which plays a role in sterol production. Sterols, such as ergosterol, are needed for membrane structure and function, making them essential for the development of functional cell walls. Therefore, exposure to these fungicides results in abnormal growth and eventually death of sensitive fungi. Demethylation fungicides include piperazines, pyridines, pyrimidines, imidazoles, triazoles and triazolinthiones. The piperazines include triforine. The pyridines include pyrifenox. The pyrimidines include fenarimol and nuarimol. The imidazoles include clotrimazole, imazalil, oxpoconazole, prochloraz, pefurazoate and triflumizole. The triazoles include azaconazole, bitertanol, bromuconazole, cyproconazole, difenoconazole, diniconazole (including diniconazole-M), epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole, uniconazole, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]methyl]-1,2-dihydro-3H-1,2,4-triazole-3-thione and rel-1-[[(2R,3S)-3-(2-chlorophenyl)-2-(2,4-difluorophenyl)-2-oxiranyl]methyl]-5-(2-propen1-ylthio)-1H-1,2,4-triazole. The imidazoles include clotrimazole, imazalil, oxpoconazole, prochloraz, pefurazoate and triflumizole. The pyrimidines include fenarimol and nuarimol. The piperazines include triforine. The pyridines include pyrifenox. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

(4) “Phenylamide fungicides” (Fungicide Resistance Action Committee (FRAC) code 4) are specific inhibitors of RNA polymerase in Oomycete fungi. Sensitive fungi exposed to these fungicides show a reduced capacity to incorporate uridine into rRNA. Growth and development in sensitive fungi is prevented by exposure to this class of fungicide. Phenylamide fungicides include acylalanines, oxazolidinones and butyrolactones. The acylalanines include benalaxyl, benalaxyl-M, furalaxyl, metalaxyl and metalaxyl-M/mefenoxam. The oxazolidinones include oxadixyl. The butyrolactones include ofurace.

(5) “Amine/morpholine fungicides” (Fungicide Resistance Action Committee (FRAC) code 5) inhibit two target sites within the sterol biosynthetic pathway, Δ⁸→Δ⁷ isomerase and Δ¹⁴ reductase. Sterols, such as ergosterol, are needed for membrane structure and function, making them essential for the development of functional cell walls. Therefore, exposure to these fungicides results in abnormal growth and eventually death of sensitive fungi. Amine/morpholine fungicides (also known as non-DMI sterol biosynthesis inhibitors) include morpholines, piperidines and spiroketal-amines. The morpholines include aldimorph, dodemorph, fenpropimorph, tridemorph and trimorphamide. The piperidines include fenpropidin and piperalin. The spiroketal-amines include spiroxamine.

(6) “Phospholipid biosynthesis inhibitor fungicides” (Fungicide Resistance Action Committee (FRAC) code 6) inhibit growth of fungi by affecting phospholipid biosynthesis. Phospholipid biosynthesis fungicides include phophorothiolates and dithiolanes. The phosphorothiolates include edifenphos, iprobenfos and pyrazophos. The dithiolanes include isoprothiolane.

(7) “Carboxamide fungicides” (Fungicide Resistance Action Committee (FRAC) code 7) inhibit Complex II (succinate dehydrogenase) fungal respiration by disrupting a key enzyme in the Krebs Cycle (TCA cycle) named succinate dehydrogenase. Inhibiting respiration prevents the fungus from making ATP, and thus inhibits growth and reproduction. Carboxamide fungicides include phenyl benzamides, pyridinyl ethyl benzamides, furan carboxamides, oxathiin carboxamides, thiazole carboxamides, pyrazole carboxamides and pyridine carboxamides. The phenyl benzamides include benodanil, flutolanil and mepronil. The pyridinyl ethyl benzamides include fluopyram. The furan carboxamides include fenfuram. The oxathiin carboxamides include carboxin and oxycarboxin. The thiazole carboxamides include thifluzamide. The pyrazole carboxamides include furametpyr, penthiopyrad, bixafen, isopyrazam, benzovindiflupyr, N-[2-(1S,2R)-[1,1′-bicyclopropyl]-2-ylphenyl]-3-(difluoromethyl)-1-methyl-1H-pyrazole-4-carboxamide, penflufen, (N-[2-(1,3-dimethylbutyl)phenyl]-5-fluoro-1,3-dimethyl-1H-pyrazole-4-carboxamide) and N-[2-(2,4-dichlorophenyl)-2-methoxy-1-methylethyl]-3-(difluoromethyl)-1-methyl-1H-pyrazole-4-carboxamide. The pyridine carboxamides include boscalid.

(8) “Hydroxy(2-amino-)pyrimidine fungicides” (Fungicide Resistance Action Committee (FRAC) code 8) inhibit nucleic acid synthesis by interfering with adenosine deaminase. Examples include bupirimate, dimethirimol and ethirimol.

(9) “Anilinopyrimidine fungicides” (Fungicide Resistance Action Committee (FRAC) code 9) are proposed to inhibit biosynthesis of the amino acid methionine and to disrupt the secretion of hydrolytic enzymes that lyse plant cells during infection. Examples include cyprodinil, mepanipyrim and pyrimethanil.

(10) “N-Phenyl carbamate fungicides” (Fungicide Resistance Action Committee (FRAC) code 10) inhibit mitosis by binding to β-tubulin and disrupting microtubule assembly. Inhibition of microtubule assembly can disrupt cell division, transport within the cell and cell structure. Examples include diethofencarb.

(11) “Quinone outside inhibitor (QoI) fungicides” (Fungicide Resistance Action Committee (FRAC) code 11) inhibit Complex III mitochondrial respiration in fungi by affecting ubiquinol oxidase. Oxidation of ubiquinol is blocked at the “quinone outside” (Qₒ) site of the cytochrome bc₁ complex, which is located in the inner mitochondrial membrane of fungi. Inhibiting mitochondrial respiration prevents normal fungal growth and development. Quinone outside inhibitor fungicides (also known as strobilurin fungicides) include methoxyacrylates, methoxycarbamates, oximinoacetates, oximinoacetamides, oxazolidinediones, dihydrodioxazines, imidazolinones and benzylcarbamates. The methoxyacrylates include azoxystrobin, coumoxystrobin, enestroburin, flufenoxystrobin, picoxystrobin and pyraoxystrobin. The methoxycarbamates include pyraclostrobin, pyrametostrobin and triclopyricarb. The oximinoacetates include kresoxim-methyl and trifloxystrobin. The oximinoacetamides include dimoxystrobin, metominostrobin, orysastrobin, α-[methoxyimino]-N-methyl-2-[[[1-[3-(trifluoromethyl)phenyl]ethoxy]imino]-methyl]benzeneacetamide and 2-[[[3-(2,6-dichlorophenyl)-1-methyl-2-propen-1-ylidene]-amino]oxy]methyl]-α-(methoxyimino)-N-methylbenzeneacetamide. The oxazolidinediones include famoxadone. The dihydrodioxazines include fluoxastrobin. The imidazolinones include fenamidone. The benzylcarbamates include pyribencarb. Class (11) also includes 2-[(2,5-dimethylphenoxy)methyl]-α-methoxy-N-benzeneacetamide.

(12) “Phenylpyrrole fungicides” (Fungicide Resistance Action Committee (FRAC) code 12) inhibit a MAP protein kinase associated with osmotic signal transduction in fungi. Fenpiclonil and fludioxonil are examples of this fungicide class.

(13) “Azanaphthalene fungicides” (Fungicide Resistance Action Committee (FRAC) code 13) are proposed to inhibit signal transduction by affecting G-proteins in early cell signaling. They have been shown to interfere with germination and/or appressorium formation in fungi that cause powder mildew diseases. Azanaphthalene fungicides include aryloxyquinolines and quinazolinone. The aryloxyquinolines include quinoxyfen and tebufloquin. The quinazolinones include proquinazid.

(14) “Lipid peroxidation inhibitor fungicides” (Fungicide Resistance Action Committee (FRAC) code 14) are proposed to inhibit lipid peroxidation which affects membrane synthesis in fungi. Members of this class, such as etridiazole, may also affect other biological processes such as respiration and melanin biosynthesis. Lipid peroxidation fungicides include aromatic carbons and 1,2,4-thiadiazoles. The aromatic carbon fungicides include biphenyl, chloroneb, dicloran, quintozene, tecnazene and tolclofos-methyl. The 1,2,4-thiadiazole fungicides include etridiazole.

(15) “Melanin biosynthesis inhibitors-reductase (MBI-R) fungicides” (Fungicide Resistance Action Committee (FRAC) code 16.1) inhibit the naphthal reduction step in melanin biosynthesis. Melanin is required for host plant infection by some fungi. Melanin biosynthesis inhibitors-reductase fungicides include isobenzofuranones, pyrroloquinolinones and triazolobenzothiazoles. The isobenzofuranones include fthalide. The pyrroloquinolinones include pyroquilon. The triazolobenzothiazoles include tricyclazole.

(16) “Melanin biosynthesis inhibitors-dehydratase (MBI-D) fungicides” (Fungicide Resistance Action Committee (FRAC) code 16.2) inhibit scytalone dehydratase in melanin biosynthesis. Melanin in required for host plant infection by some fungi. Melanin biosynthesis inhibitors-dehydratase fungicides include cyclopropanecarboxamides, carboxamides and propionamides. The cyclopropanecarboxamides include carpropamid. The carboxamides include diclocymet. The propionamides include fenoxanil.

(17) “Hydroxyanilide fungicides (Fungicide Resistance Action Committee (FRAC) code 17) inhibit C4-demethylase which plays a role in sterol production. Examples include fenhexamid.

(18) “Squalene-epoxidase inhibitor fungicides” (Fungicide Resistance Action Committee (FRAC) code 18) inhibit squalene-epoxidase in ergosterol biosynthesis pathway. Sterols such as ergosterol are needed for membrane structure and function, making them essential for the development of functional cell walls. Therefore exposure to these fungicides results in abnormal growth and eventually death of sensitive fungi. Squalene-epoxidase inhibitor fungicides include thiocarbamates and allylaminess. The thiocarbamates include pyributicarb. The allylamines include naftifine and terbinafine.

(19) “Polyoxin fungicides” (Fungicide Resistance Action Committee (FRAC) code 19) inhibit chitin synthase. Examples include polyoxin.

(20) “Phenylurea fungicides” (Fungicide Resistance Action Committee (FRAC) code 20) are proposed to affect cell division. Examples include pencycuron.

(21) “Quinone inside inhibitor (QiI) fungicides” (Fungicide Resistance Action Committee (FRAC) code 21) inhibit Complex III mitochondrial respiration in fungi by affecting ubiquinol reductase. Reduction of ubiquinol is blocked at the “quinone inside” (Qᵢ) site of the cytochrome bc₁ complex, which is located in the inner mitochondrial membrane of fungi. Inhibiting mitochondrial respiration prevents normal fungal growth and development. Quinone inside inhibitor fungicides include cyanoimidazoles and sulfamoyltriazoles. The cyanoimidazoles include cyazofamid. The sulfamoyltriazoles include amisulbrom.

(22) “Benzamide fungicides” (Fungicide Resistance Action Committee (FRAC) code 22) inhibit mitosis by binding to β-tubulin and disrupting microtubule assembly Inhibition of microtubule assembly can disrupt cell division, transport within the cell and cell structure. Examples include zoxamide.

(23) “Enopyranuronic acid antibiotic fungicides” (Fungicide Resistance Action Committee (FRAC) code 23) inhibit growth of fungi by affecting protein biosynthesis. Examples include blasticidin-S.

(24) “Hexopyranosyl antibiotic fungicides” (Fungicide Resistance Action Committee (FRAC) code 24) inhibit growth of fungi by affecting protein biosynthesis. Examples include kasugamycin.

(25) “Glucopyranosyl antibiotic: protein synthesis fungicides” (Fungicide Resistance Action Committee (FRAC) code 25) inhibit growth of fungi by affecting protein biosynthesis. Examples include streptomycin.

(26) “Glucopyranosyl antibiotic: trehalase and inositol biosynthesis fungicides” (Fungicide Resistance Action Committee (FRAC) code 26) inhibit trehalase in inositol biosynthesis pathway. Examples include validamycin.

(27) “Cyanoacetamideoxime fungicides (Fungicide Resistance Action Committee (FRAC) code 27) include cymoxanil.

(28) “Carbamate fungicides” (Fungicide Resistance Action Committee (FRAC) code 28) are considered multi-site inhibitors of fungal growth. They are proposed to interfere with the synthesis of fatty acids in cell membranes, which then disrupts cell membrane permeability. Propamacarb, propamacarb-hydrochloride, iodocarb, and prothiocarb are examples of this fungicide class.

(29) “Oxidative phosphorylation uncoupling fungicides” (Fungicide Resistance Action Committee (FRAC) code 29) inhibit fungal respiration by uncoupling oxidative phosphorylation. Inhibiting respiration prevents normal fungal growth and development. This class includes 2,6-dinitroanilines such as fluazinam, pyrimidonehydrazones such as ferimzone and dinitrophenyl crotonates such as dinocap, meptyldinocap and binapacryl.

(30) “Organo tin fungicides” (Fungicide Resistance Action Committee (FRAC) code 30) inhibit adenosine triphosphate (ATP) synthase in oxidative phosphorylation pathway. Examples include fentin acetate, fentin chloride and fentin hydroxide.

(31) “Carboxylic acid fungicides” (Fungicide Resistance Action Committee (FRAC) code 31) inhibit growth of fungi by affecting deoxyribonucleic acid (DNA) topoisomerase type II (gyrase). Examples include oxolinic acid.

(32) “Heteroaromatic fungicides” (Fungicide Resistance Action Committee (FRAC) code 32) are proposed to affect DNA/ribonucleic acid (RNA) synthesis. Heteroaromatic fungicides include isoxazoles and isothiazolones. The isoxazoles include hymexazole and the isothiazolones include octhilinone.

(33) “Phosphonate fungicides” (Fungicide Resistance Action Committee (FRAC) code 33) include phosphorous acid and its various salts, including fosetyl-aluminum.

(34) “Phthalamic acid fungicides” (Fungicide Resistance Action Committee (FRAC) code 34) include teclofthalam.

(35) “Benzotriazine fungicides” (Fungicide Resistance Action Committee (FRAC) code 35) include triazoxide.

(36) “Benzene-sulfonamide fungicides” (Fungicide Resistance Action Committee (FRAC) code 36) include flusulfamide.

(37) “Pyridazinone fungicides” (Fungicide Resistance Action Committee (FRAC) code 37) include diclomezine.

(38) “Thiophene-carboxamide fungicides” (Fungicide Resistance Action Committee (FRAC) code 38) are proposed to affect ATP production. Examples include silthiofam.

(39) “Pyrimidinamide fungicides” (Fungicide Resistance Action Committee (FRAC) code 39) inhibit growth of fungi by affecting phospholipid biosynthesis and include diflumetorim.

(40) “Carboxylic acid amide (CAA) fungicides” (Fungicide Resistance Action Committee (FRAC) code 40) are proposed to inhibit phospholipid biosynthesis and cell wall deposition. Inhibition of these processes prevents growth and leads to death of the target fungus. Carboxylic acid amide fungicides include cinnamic acid amides, valinamide carbamates, carbamates and mandelic acid amides. The cinnamic acid amides include dimethomorph and flumorph. The valinamide carbamates include benthiavalicarb, benthiavalicarb-isopropyl, iprovalicarb, valifenalate and valiphenal. The carbamates include tolprocarb. The mandelic acid amides include mandipropamid, N-[2-[4-[[3-(4-chlorophenyl)-2-propyn-1-yl]oxy]-3-methoxyphenyl]ethyl]-3-methyl-2-[(methylsulfonyl)-amino]butanamide and N-[2-[4-[[3-(4-chlorophenyl)-2-propyn-1-yl]oxy]-3-methoxyphenyl]-ethyl]-3-methyl-2-[(ethylsulfonyl)amino]butanamide.

(41) “Tetracycline antibiotic fungicides” (Fungicide Resistance Action Committee (FRAC) code 41) inhibit growth of fungi by affecting complex 1 nicotinamide adenine dinucleotide (NADH) oxidoreductase. Examples include oxytetracycline.

(42) “Thiocarbamate fungicides” (Fungicide Resistance Action Committee (FRAC) code 42) include methasulfocarb.

(43) “Benzamide fungicides” (Fungicide Resistance Action Committee (FRAC) code 43) inhibit growth of fungi by delocalization of spectrin-like proteins. Examples include acylpicolide fungicides such as fluopicolide.

(44) “Host plant defense induction fungicides” (Fungicide Resistance Action Committee (FRAC) code P) induce host plant defense mechanisms. Host plant defense induction fungicides include benzothiadiazoles, benzisothiazoles and thiadiazolecarboxamides. The benzothiadiazoles include acibenzolar-S-methyl. The benzisothiazoles include probenazole, The thiadiazolecarboxamides include tiadinil and isotianil.

(45) “Multi-site contact fungicides” inhibit fungal growth through multiple sites of action and have contact/preventive activity. This class of fungicides includes: (45.1) “copper fungicides” (Fungicide Resistance Action Committee (FRAC) code M1)”, (45.2) “sulfur fungicides” (Fungicide Resistance Action Committee (FRAC) code M2), (45.3) “dithiocarbamate fungicides” (Fungicide Resistance Action Committee (FRAC) code M3), (45.4) “phthalimide fungicides” (Fungicide Resistance Action Committee (FRAC) code M4), (45.5) “chloronitrile fungicides” (Fungicide Resistance Action Committee (FRAC) code M5), (45.6) “sulfamide fungicides” (Fungicide Resistance Action Committee (FRAC) code M6), (45.7) “guanidine fungicides” (Fungicide Resistance Action Committee (FRAC) code M7), (45.8) “triazine fungicides” (Fungicide Resistance Action Committee (FRAC) code M8) and (45.9) “quinone fungicides” (Fungicide Resistance Action Committee (FRAC) code M9). “Copper fungicides” are inorganic compounds containing copper, typically in the copper(II) oxidation state; examples include copper oxychloride, copper sulfate and copper hydroxide, including compositions such as Bordeaux mixture (tribasic copper sulfate). “Sulfur fungicides” are inorganic chemicals containing rings or chains of sulfur atoms; examples include elemental sulfur. “Dithiocarbamate fungicides” contain a dithiocarbamate molecular moiety; examples include mancozeb, metiram, propineb, ferbam, maneb, thiram, zineb and ziram. “Phthalimide fungicides” contain a phthalimide molecular moiety; examples include folpet, captan and captafol. “Chloronitrile fungicides” contain an aromatic ring substituted with chloro and cyano; examples include chlorothalonil. “Sulfamide fungicides” include dichlofluanid and tolyfluanid. “Guanidine fungicides” include dodine, guazatine, iminoctadine albesilate and iminoctadine triacetate. “Triazine fungicides” include anilazine. “Quinone fungicides” include dithianon.

(46) “Fungicides other than fungicides of classes (1) through (45)” include certain fungicides whose mode of action may be unknown. These include: (46.1) “thiazole carboxamide fungicides” (Fungicide Resistance Action Committee (FRAC) code U5), (46.2) “phenylacetamide fungicides” (Fungicide Resistance Action Committee (FRAC) code U6), (46.3) “arylphenylketone fungicides” (Fungicide Resistance Action Committee (FRAC) code U8) and (46.4) “triazolopyrimidine fungicides”. The thiazole carboxamides include ethaboxam. The phenylacetamides include cyflufenamid and N-[[(cyclopropylmethoxy)-amino][6-(difluoromethoxy)-2,3-difluorophenyl]-methylene]benzeneacetamide. The arylphenylketones include benzophenones such as metrafenone and benzoylpyridines such as pyriofenone. The triazolopyrimidines include ametoctradin. Class (46) (i.e. “Fungicides other than classes (1) through (45)”) also includes bethoxazin, fluxapyroxad, neo-asozin (ferric methanearsonate), pyrrolnitrin, quinomethionate, tebufloquin, isofetamid, N-[2-[4-[[3-(4-chlorophenyl)-2-propyn-1-yl]oxy]-3-methoxyphenyl]ethyl]-3-methyl-2-[(methylsulfonyl)amino]butanamide, N-[2-[4-[[3-(4-chlorophenyl)-2-propyn-1-yl]oxy]-3-methoxyphenyl]ethyl]-3-methyl-2-[(ethylsulfonyl)amino]butanamide, 2-[[2-fluoro-5-(trifluoromethyl)phenyl]thio]-2-[3-(2-methoxyphenyl)-2-thiazolidinylidene]acetonitrile, 3-[5-(4-chlorophenyl)-2,3-dimethyl-3-isoxazolidinyl]pyridine, 4-fluorophenyl N-[1-[[[1-(4-cyanophenyl ethyl]sulfonyl]methyl]propyl]carbamate, 5-chloro-6-(2,4,6-trifluorophenyl)-7-(4-methylpiperidin-1-yl) [1,2,4]triazolo[1,5-a]pyrimidine, N-(4-chloro-2-nitrophenyl)-N-ethyl-4-methylbenzenesulfonamide, N-[[(cyclopropylmethoxy)amino][6-(difluoromethoxy)-2,3-difluorophenyl]methylene]benzeneacetamide, N-[4-[4-chloro-3-(trifluoromethyl)-phenoxy]-2,5-dimethylphenyl]-N-ethyl-N-methylmethanimidamide, 1-[(2-propenylthio)carbonyl]-2-(1-methylethyl)-4-(2-methylphenyl)-5-amino-1H-pyrazol-3-one, N-[4-[[3-[(4-chlorophenyl)methyl]-1,2,4-thiadiazol-5-yl]oxy]-2,5-dimethylphenyl]-N-ethyl-N-methyl-methanimidamide, 1,1-dimethylethyl N-[6-[[[[(1-methyl-1H-tetrazol-5-yl)phenylmethylene]amino]oxy]methyl]-2-pyridinyl]carbamate, 3-butyn-1-yl N-[6-[[[[(1-methyl-1H-tetrazol-5-yl)phenylmethylene]amino]oxy]methyl]-2-pyridinyl]carbamate, 2,6-dimethyl-1H,5H-[1,4]dithiino[2,3-c:5,6-c′]dipyrrole-1,3,5,7(2H,6H)-tetrone, 5-fluoro-2-[(4-methylphenyl)methoxy]-4-pyrimidinamine and 5-fluoro-2-[(4-fluorophenyl)methoxy]-4-pyrimidinamine.

Therefore of note is a mixture (i.e. composition) comprising a compound of Formula 1 and at least one fungicidal compound selected from the group consisting of the aforedescribed classes (1) through (46). Also of note is a composition comprising said mixture (in fungicidally effective amount) and further comprising at least one additional component selected from the group consisting of surfactants, solid diluents and liquid diluents. Of particular note is a mixture (i.e. composition) comprising a compound of Formula 1 and at least one fungicidal compound selected from the group of specific compounds listed above in connection with classes (1) through (46). Also of particular note is a composition comprising said mixture (in fungicidally effective amount) and further comprising at least one additional surfactant selected from the group consisting of surfactants, solid diluents and liquid diluents.

Examples of other biologically active compounds or agents with which compounds of this invention can be formulated are: insecticides such as abamectin, acephate, acetamiprid, acrinathrin, amidoflumet (S-1955), avermectin, azadirachtin, azinphos-methyl, bifenthrin, bifenazate, buprofezin, carbofuran, cartap, chlorantraniliprole, chlorfenapyr, chlorfluazuron, chlorpyrifos, chlorpyrifos-methyl, chromafenozide, clothianidin, cyantraniliprole (3-bromo-1-(3-chloro-2-pyridinyl)-N-[4-cyano-2-methyl-6-[(methylamino)carbonyl]phenyl]-1H-pyrazole-5-carboxamide), cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, meperfluthrin, metaflumizone, metaldehyde, methamidophos, methidathion, methomyl, methoprene, methoxychlor, methoxyfenozide, metofluthrin, milbemycin oxime, monocrotophos, nicotine, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulfoxaflor, sulprofos, tebufenozide, teflubenzuron, tefluthrin, terbufos, tetrachlorvinphos, tetramethylfluthrin, thiacloprid, thiamethoxam, thiodicarb, thiosultap-sodium, tolfenpyrad, tralomethrin, triazamate, trichlorfon and triflumuron; and biological agents including entomopathogenic bacteria, such as Bacillus thuringiensis subsp. aizawai, Bacillus thuringiensis subsp. kurstaki, and the encapsulated delta-endotoxins of Bacillus thuringiensis (e.g., Cellcap, MPV, MPVII); entomopathogenic fungi, such as green muscardine fungus; and entomopathogenic virus including baculovirus, nucleopolyhedro virus (NPV) such as HzNPV, AfNPV; and granulosis virus (GV) such as CpGV.

Compounds of this invention and compositions thereof can be applied to plants genetically transformed to express proteins toxic to invertebrate pests (such as Bacillus thuringiensis delta-endotoxins). The effect of the exogenously applied fungicidal compounds of this invention may be synergistic with the expressed toxin proteins.

General references for agricultural protectants (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to the compound of Formula 1 is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of diseases controlled beyond the spectrum controlled by the compound of Formula 1 alone.

In certain instances, combinations of a compound of this invention with other biologically active (particularly fungicidal) compounds or agents (i.e. active ingredients) can result in a greater-than-additive (i.e. synergistic) effect. Reducing the quantity of active ingredients released in the environment while ensuring effective pest control is always desirable. When synergism of fungicidal active ingredients occurs at application rates giving agronomically satisfactory levels of fungal control, such combinations can be advantageous for reducing crop production cost and decreasing environmental load.

Of note is a combination of a compound of Formula 1 with at least one other fungicidal active ingredient. Of particular note is such a combination where the other fungicidal active ingredient has different site of action from the compound of Formula 1. In certain instances, a combination with at least one other fungicidal active ingredient having a similar spectrum of control but a different site of action will be particularly advantageous for resistance management. Thus, a composition of the present invention can further comprise a biologically effective amount of at least one additional fungicidal active ingredient having a similar spectrum of control but a different site of action.

Of particular note are compositions which in addition to compound of Formula 1 include at least one compound selected from the group consisting of (1) alkylenebis(dithiocarbamate) fungicides; (2) cymoxanil; (3) phenylamide fungicides; (4) proquinazid (6-iodo-3-propyl-2-propyloxy-4(3H)-quinazolinone); (5) chlorothalonil; (6) carboxamides acting at complex II of the fungal mitochondrial respiratory electron transfer site; (7) quinoxyfen; (8) metrafenone; (9) cyflufenamid; (10) cyprodinil; (11) copper compounds; (12) phthalimide fungicides; (13) fosetyl-aluminum; (14) benzimidazole fungicides; (15) cyazofamid; (16) fluazinam; (17) iprovalicarb; (18) propamocarb; (19) validomycin; (20) dichlorophenyl dicarboximide fungicides; (21) zoxamide; (22) fluopicolide; (23) mandipropamid; (24) carboxylic acid amides acting on phospholipid biosynthesis and cell wall deposition; (25) dimethomorph; (26) non-DMI sterol biosynthesis inhibitors; (27) inhibitors of demethylase in sterol biosynthesis; (28) bc₁ complex fungicides; and salts of compounds of (1) through (28).

Further descriptions of classes of fungicidal compounds are provided below.

Sterol biosynthesis inhibitors (group (27)) control fungi by inhibiting enzymes in the sterol biosynthesis pathway. Demethylase-inhibiting fungicides have a common site of action within the fungal sterol biosynthesis pathway, involving inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides are divided between several chemical classes: azoles (including triazoles and imidazoles), pyrimidines, piperazines and pyridines. The triazoles include azaconazole, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole and uniconazole. The imidazoles include clotrimazole, econazole, imazalil, isoconazole, miconazole, oxpoconazole, prochloraz and triflumizole. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

bc₁ Complex Fungicides (group 28) have a fungicidal mode of action which inhibits the bc₁ complex in the mitochondrial respiration chain. The bc₁ complex is sometimes referred to by other names in the biochemical literature, including complex III of the electron transfer chain, and ubihydroquinone:cytochrome c oxidoreductase. This complex is uniquely identified by Enzyme Commission number EC1.10.2.2. The bc₁ complex is described in, for example, J. Biol. Chem. 1989, 264, 14543-48; Methods Enzymol. 1986, 126, 253-71; and references cited therein. Strobilurin fungicides such as azoxystrobin, dimoxystrobin, enestroburin (SYP-Z071), fluoxastrobin, kresoxim-methyl, metominostrobin, orysastrobin, picoxystrobin, pyraclostrobin, pyrametostrobin, pyraoxystrobin and trifloxystrobin are known to have this mode of action (H. Sauter et al., Angew. Chem. Int. Ed. 1999, 38, 1328-1349). Other fungicidal compounds that inhibit the bc₁ complex in the mitochondrial respiration chain include famoxadone and fenamidone.

Alkylenebis(dithiocarbamate)s (group (1)) include compounds such as mancozeb, maneb, propineb and zineb. Phenylamides (group (3)) include compounds such as metalaxyl, benalaxyl, furalaxyl and oxadixyl. Carboxamides (group (6)) include compounds such as boscalid, carboxin, fenfuram, flutolanil, furametpyr, mepronil, oxycarboxin, thifluzamide, penthiopyrad and N-[2-(1,3-dimethylbutyl)phenyl]-5-fluoro-1,3-dimethyl-1H-pyrazole-4-carboxamide (PCT Patent Publication WO 2003/010149), and are known to inhibit mitochondrial function by disrupting complex II (succinate dehydrogenase) in the respiratory electron transport chain. Copper compounds (group (11)) include compounds such as copper oxychloride, copper sulfate and copper hydroxide, including compositions such as Bordeaux mixture (tribasic copper sulfate). Phthalimides (group (12)) include compounds such as folpet and captan. Benzimidazole fungicides (group (14)) include benomyl and carbendazim. Dichlorophenyl dicarboximide fungicides (group (20)) include chlozolinate, dichlozoline, iprodione, isovaledione, myclozolin, procymidone and vinclozolin.

Non-DMI sterol biosynthesis inhibitors (group (26)) include morpholine and piperidine fungicides. The morpholines and piperidines are sterol biosynthesis inhibitors that have been shown to inhibit steps in the sterol biosynthesis pathway at a point later than the inhibitions achieved by the DMI sterol biosynthesis (group (27)). The morpholines include aldimorph, dodemorph, fenpropimorph, tridemorph and trimorphamide. The piperidines include fenpropidin.

Of further note are combinations of compounds of Formula 1 with azoxystrobin, kresoxim-methyl, trifloxystrobin, pyraclostrobin, picoxystrobin, dimoxystrobin, metominostrobin/fenominostrobin, carbendazim, chlorothalonil, quinoxyfen, metrafenone, cyflufenamid, fenpropidine, fenpropimorph, bromuconazole, cyproconazole, difenoconazole, epoxiconazole, fenbuconazole, flusilazole, hexaconazole, ipconazole, metconazole, penconazole, propiconazole, proquinazid, prothioconazole, tebuconazole, triticonazole, famoxadone, prochloraz, penthiopyrad and boscalid (nicobifen).

The control efficacy of compounds of this invention on specific pathogens is demonstrated in TABLE A below. The pathogen control protection afforded by the compounds is not limited, however, to the species described in Tests A-G below. Descriptions of the compounds are provided in Index Table A below. The following abbreviations are used in the index table: Me is methyl, Ph is phenyl, “Cmpd. No.” means compound number, and “Ex.” stands for “Example” and is followed by a number indicating in which example the compound is prepared. In Index Table A, mass spectra are reported as the molecular weight of the highest isotopic abundance parent ion (M+1) formed by addition of H+(molecular weight of 1) to the molecule, or (M−1) formed by the loss of H+(molecular weight of 1) from the molecule, observed by using an liquid chromatography coupled to a mass spectrometer (LCMS) using either atmospheric pressure chemical ionization (AP⁺) or electrospray ionization (ESI⁺).

INDEX TABLE A

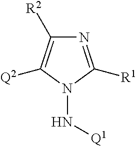

| Cmpd. | | | | | M + | M − |
|---|---|---|---|---|---|---|
| No. | R¹ | R² | Q¹ | Q² | 1 | 1 |
| 1 | H | Me | 2-Cl-4-F—Ph | 2,4-di-F—Ph | 338 | 336 |
| 2 | Br | Me | 2-Cl-4-F—Ph | 2,4-di-F—Ph | 416 | 414 |
| 3 | H | Me | 2,4-di-Cl—Ph | 4-F—Ph | 336 | 334 |
| 4 | H | Me | 2-Cl-4-F—Ph | 2,4-di-F—Ph | — | 396 |
| 5 | Br | Me | 2,4-di-Cl—Ph | 4-Cl—Ph | 432 | 430 |
| 6 | Br | Me | 2,4-di-Cl—Ph | 4-F—Ph | 416 | 414 |
| 7 | H | Me | 2,4-di-Cl—Ph | 2,4-di-F—Ph | 354 | 352 |
| (Ex. 1) | | | | | | |
| 8 | Br | Me | 2-Br-4,6-di-Cl—Ph | 2,4-di-F—Ph | 512 | — |
| (Ex. 2) | | | | | | |
| 9 | H | Me | 2,4-di-F—Ph | 2,4-di-F—Ph | 322 | 320 |
| 10 | Br | Me | 2,4-di-F—Ph | 2,4-di-F—Ph | 400 | 398 |
| 11 | Cl | Cl | 2-Cl-4,6-di-F—Ph | 2,4-di-Cl—Ph | ** | ** |
| (Ex. 3) | | | | | | |
| 12 | Cl | CHCl₂ | 2-Cl-4-F—Ph | 2,4-di-F—Ph | * | * |
| 13 | Cl | CH₂Cl | 2-Cl-4-F—Ph | 2,4-di-F—Ph | * | * |
| 14 | Br | Br | 2,4-di-F—Ph | 2,4-di-Cl—Ph | 497 | |

* See Index Table B for ¹H NMR data.
** See synthesis example for ¹H NMR.

INDEX TABLE B

| Cmpd No. | ¹H NMR Data (CDCl₃ solution unless indicated otherwise)^{a} |
|---|---|
| 12 | δ 7.77 (s, 1H), 7.10 (dt, 1H), 7.05 (s, 1H), 6.94 (dd, 1H), |
| | 6.84-6.89 (m, 2H), 6.74 (dt, 1H), 6.13 (dd, 1H). |
| 13 | δ 8.07 (q, 1H), 7.12 (bs, 1H), 6.81-7.03 (m, 4H), |
| | 6.17 (dd, 1H), 4.47 (s, 2H). |

^{a1}H NMR data are in ppm downfield from tetramethylsilane. Couplings are designated by (s)—singlet, (q)—quartet, (m)—multiplet, (dd)—doublet of doublets, (dt)—doublet of triplets and (br s)—broad singlet.

### Biological Examples of the Invention

General protocol for preparing test suspensions for Tests A-G: the test compounds were first dissolved in acetone in an amount equal to 3% of the final volume and then suspended at the desired concentration (in ppm) in acetone and purified water (50/50 mix by volume) containing 250 ppm of the surfactant Trem® 014 (polyhydric alcohol esters). The resulting test suspensions were then used in Tests A-G. Each test was conducted in triplicate, and the results were averaged. Spraying a 40 ppm test suspension to the point of run-off on the test plants was the equivalent of a rate of about 160 g/ha. Unless otherwise indicated, the rating values indicate a 40 ppm test suspension was used.

### Test A

The test suspension was sprayed to the point of run-off on tomato seedlings. The following day the seedlings were inoculated with a spore suspension of Botrytis cinerea (the causal agent of tomato Botrytis) and incubated in saturated atmosphere at 20° C. for 48 h, and then moved to a growth chamber at 24° C. for 3 additional days, after which time visual disease ratings were made.

### Test B

The test suspension was sprayed to the point of run-off on tomato seedlings. The following day the seedlings were inoculated with a spore suspension of Alternaria solani (the causal agent of tomato early blight) and incubated in a saturated atmosphere at 27° C. for 48 h, and then moved to a growth chamber at 20° C. for 5 days, after which time visual disease ratings were made.

### Test C

The test suspension was sprayed to the point of run-off on wheat seedlings. The following day the seedlings were inoculated with a spore suspension of Septoria nodorum (the causal agent of Septoria glume blotch) and incubated in a saturated atmosphere at 24° C. for 48 h, and then moved to a growth chamber at 20° C. for 9 days, after which time visual disease ratings were made.

### Test D

The test suspension was sprayed to the point of run-off on wheat seedlings. The following day the seedlings were inoculated with a spore suspension of Septoria tritici (the causal agent of wheat leaf blotch) and incubated in saturated atmosphere at 24° C. for 48 h. and then the seedlings were moved to a growth chamber at 20° C. for 19 additional days, after which time visual disease ratings were made.

### Test E

Wheat seedlings were inoculated with a spore suspension of Puccinia recondite f. sp. tritici (the causal agent of wheat leaf rust) and incubated in a saturated atmosphere at 20° C. for 24 h, and then moved to a growth chamber at 20° C. for 2 days. After 2 days, the test suspension was sprayed to the point of run-off on the wheat seedlings, and then the seedlings were moved back to the growth chamber at 20° C. for 4 days. Upon removal, visual disease ratings were made.

### Test F

The test suspension was sprayed to the point of run-off on wheat seedlings. The following day the seedlings were inoculated with a spore suspension of Puccinia recondite f. sp. tritici (the causal agent of wheat leaf rust) and incubated in a saturated atmosphere at 20° C. for 24 h, and then moved to a growth chamber at 20° C. for 6 days, after which time visual disease ratings were made.

### Test G

The test suspension was sprayed to the point of run-off on wheat seedlings. The following day the seedlings were inoculated with a spore dust of Blumeria graminis f. sp. tritici (also known as Erysiphe graminis f. sp. tritici, the causal agent of wheat powdery mildew) and incubated in a growth chamber at 20° C. for 8 days, after which time visual disease ratings were made.

Results for Tests A-G are given in Table A. In the Table, a rating of 100 indicates 100% disease control and a rating of 0 indicates no disease control (relative to the controls). A hyphen (-) indicates no test results.

TABLE A

| Cmpd | | | | | | | Test |
|---|---|---|---|---|---|---|---|
| No. | Test A | Test B | Test C | Test D | Test E | Test F | G |
| 1 | 100 | 70 | 0 | 92 | — | 95 | 91 |
| 2 | 99 | 0 | 60 | 100 | 30 | 99 | 100 |
| 3 | — | 0 | 0 | 99 | 0 | 41 | 0 |
| 4 | — | 0 | 0 | 88 | 0 | 0 | 0 |
| 5 | — | 0 | 0 | 99 | 0 | 9 | 0 |
| 6 | 16 | 0 | 0 | 93 | — | 55 | 0 |
| 7 | 100 | 0 | 0 | 100 | 0 | 97 | 91 |
| 8 | 99 | 9 | 0 | 100 | 19 | 100 | 98 |
| 9 | 87 | 0 | 0 | 79 | 36 | 14 | 0 |
| 10 | 99 | 40 | 0 | 100 | 7 | 100 | 96 |
| 11 | 0 | 0 | 0 | 0 | 0 | 0 | 52 |
| 12 | 0 | 0 | 0 | 89 | 0 | 86 | 73 |
| 13 | 66 | 0 | 0 | 97 | 0 | 95 | 98 |
| 14 | 0 | 0 | 0 | 0 | 0 | 0 | 0 |

What is claimed is:

1. A compound selected from Formula 1, N-oxides and salts thereof, 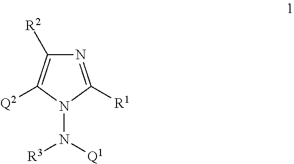
wherein
Q¹ is a phenyl, thienyl, pyridinyl, pyridazinyl, pyrazinyl or pyrimidinyl ring, each ring optionally substituted with up to 5 substituents independently selected from R^{4a};
Q² is a phenyl, thienyl, pyridinyl, pyridazinyl, pyrazinyl or pyrimidinyl ring, each ring optionally substituted with up to 5 substituents independently selected from R^{4b};
R¹ is H, halogen, cyano, nitro, C₁-C₃ alkyl, C₂-C₃ alkenyl, C₂-C₃ alkynyl, C₁-C₃ haloalkyl, C₂-C₃ haloalkenyl, cyclopropyl, C₁-C₃ hydroxyalkyl, C₂-C₃ cyanoalkyl, C₂-C₃ alkoxyalkyl, C₁-C₃ alkoxy, C₁-C₃ haloalkoxy, C₁-C₃ alkylthio or C₁-C₃ haloalkylthio;
R² is H, halogen, cyano, nitro, C₁-C₃ alkyl, C₂-C₃ alkenyl, C₂-C₃ alkynyl, C₁-C₃ haloalkyl, C₂-C₃ haloalkenyl, cyclopropyl, C₁-C₃ hydroxyalkyl, C₂-C₃ cyanoalkyl, C₂-C₃ alkoxyalkyl, C₁-C₃ alkoxy, C₁-C₃ haloalkoxy, C₁-C₃ alkylthio or C₁-C₃ haloalkylthio;
R³ is H, hydroxy, —CH(═O), C₁-C₆ alkyl, C₂-C₆ alkenyl, C₂-C₆ alkynyl, C₁-C₆ haloalkyl, C₃-C₆ cycloalkyl, C₃-C₆ halocycloalkyl, C₄-C₆ alkylcycloalkyl, C₄-C₆ cycloalkylalkyl, C₂-C₆ alkoxyalkyl, C₂-C₆ cyanoalkyl, C₂-C₆ alkylthioalkyl, C₂-C₆ alkylsulfinylalkyl, C₂-C₆ alkylsulfonylalkyl, C₂-C₆ alkylaminoalkyl, C₃-C₆ dialkylaminoalkyl, C₁-C₆ alkoxy, C₁-C₆ haloalkoxy, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₂-C₆ alkylcarbonyl, C₂-C₆ alkoxycarbonyl, C₂-C₆ (alkylthio)carbonyl, C₂-C₆ alkyl(thiocarbonyl), C₂-C₆ alkoxy(thiocarbonyl) or —S(═O)₂OM;
each R^{4a} and R^{4b} is independently halogen, cyano, hydroxy, nitro, C₁-C₃ alkyl, C₂-C₃ alkenyl, C₂-C₃ alkynyl, C₁-C₃ haloalkyl, C₂-C₃ haloalkenyl, cyclopropyl, C₂-C₃ cyanoalkyl, C₁-C₃ alkoxy, C₁-C₃ haloalkoxy, C₁-C₃ alkylthio, C₁-C₃ haloalkylthio, C₁-C₃ alkylsulfinyl, C₁-C₃ haloalkylsulfinyl, C₁-C₃ alkylsulfonyl, C₁-C₃ haloalkylsulfonyl, C₂-C₃ alkylcarbonyl, C₁-C₃ alkylamino, C₂-C₃ dialkylamino, C₂-C₃ alkylcarbonylamino, —SC≡N, —C(≡W)NH₂ or -T-U—V;
each T is independently O, S(═O)ₙ, NR⁵ or a direct bond;
each U is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are independently selected from C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each V is independently cyano, N(R^{6a})(R^{6b}), OR⁷ or S(═O)—R⁷;
each R⁵ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{6a} and R^{6b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{6a} and R^{6b} are taken together with the nitrogen atom to which they are attached to form a 3- to 6-membered heterocyclic ring, the ring optionally substituted with up to 5 substituents independently selected from R⁸;
each R⁷ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R⁸ is independently halogen, C₁-C₆ alkyl, C₁-C₆ haloalkyl or C₁-C₆ alkoxy;
each W is independently O or S;
M is K, Na or Li;
each n is independently 0, 1 or 2;
provided that:
(a) when R¹ is H, R² is other than H;
(b) the compound is other than N-(2,5-dichlorophenyl)-4-methyl-5-phenyl-1H-imidazol-1-amine; and
(c) when Q¹ and Q² are each an optionally substituted phenyl ring, then Q¹ is substituted with at least one R^{4a} at an otho position, or Q² is substituted with at least one R^{4b} at an otho position.

2. A compound of claim 1 wherein:
Q¹ is a phenyl, pyridinyl or pyrimidinyl ring, each ring optionally substituted with up to 3 substituents independently selected from R^{4a};
Q² is a phenyl, pyridinyl or pyrimidinyl ring, each ring optionally substituted with up to 3 substituents independently selected from R^{4b};
R¹ and R² are each independently H, halogen, C₁-C₃ alkyl, C₁-C₃ haloalkyl or cyclopropyl;
R³ is H, hydroxy, —CH(═O), C₁-C₃ alkyl, C₁-C₃ haloalkyl, C₂-C₃ alkoxyalkyl, C₁-C₃ alkoxy, C₁-C₃ alkylsulfinyl, C₁-C₃ alkylsulfonyl, C₂-C₃ alkylcarbonyl, C₂-C₃ alkoxycarbonyl or —S(═O)₂OM;
each R^{4a} and R^{4b} is independently halogen, cyano, C₁-C₂ alkyl, C₁-C₂ haloalkyl, cyclopropyl, C₁-C₂ alkoxy, C₁-C₃ alkylthio, C₁-C₂ alkylamino, C₂-C₄ dialkylamino, C₂-C₄ alkylcarbonyl or -T-U—V;
each T is independently O, NH or a direct bond;
each U is independently C₁-C₃ alkylene, wherein up to 1 carbon atom is selected from C(═O);
each V is independently N(R^{6a})(R^{6b}) or OR⁷;
each R^{6a} and R^{6b} is independently H or methyl; and
each R⁷ is independently H, methyl or halomethyl.

3. A compound of claim 2 wherein:
Q¹ is a phenyl or pyridinyl ring, each ring optionally substituted with up to 3 substituents independently selected from R^{4a};
Q² is a phenyl or pyridinyl ring, each ring optionally substituted with up to 3 substituents independently selected from R^{4b};
R¹ and R² are each independently H, halogen, methyl or cyclopropyl;
R³ is H or methyl; and
each R^{4a} and R^{4b} is independently halogen, cyano, C₁-C₂ alkyl, C₁-C₂ haloalkyl or C₁-C₂ alkoxy.

4. A compound of claim 3 wherein:
Q¹ is a phenyl ring optionally substituted with up to 3 substituents independently selected from R^{4a};
Q² is a phenyl ring optionally substituted with up to 3 substituents independently selected from R^{4b};
R¹ and R² are each independently halogen or methyl;
R³ is H; and
each R^{4a} and R^{4b} is independently halogen, cyano, methyl, halomethyl or methoxy.

5. A compound of claim 4 wherein:
Q¹ is a phenyl ring substituted with 1 to 3 substituents independently selected from R^{4a};
Q² is a phenyl ring substituted with 1 to 3 substituents independently selected from R^{4b};
R¹ and R² are each independently Cl, Br or methyl; and
each R^{4a} and R^{4b} is independently Br, Cl, F, cyano, methyl, trifluoromethyl or methoxy.

6. A compound of claim 5 wherein:
one of Q¹ and Q² is substituted with 2 or 3 substituents and the other of Q¹ and Q² is substituted with 1 or 2 substituents; and
each R^{4a} and R^{4b} is independently Br, Cl or F.

7. The compound of claim 1 which is selected from the group consisting of:
N-(2-chloro-4-fluorophenyl)-5-(2,4-difluorophenyl)-4-methyl-1H-imidazol-1-amine;
2-bromo-N-(2-chloro-4-fluorophenyl)-5-(2,4-difluorophenyl)-4-methyl-1H-imidazol-1-amine;
N-(2,4-chlorophenyl)-5-(2,4-difluorophenyl)-4-methyl-1H-imidazol-1-amine;
2-bromo-N-(2-bromo-4,6-chlorophenyl)-5-(2,4-difluorophenyl)-4-methyl-1H-imidazol-1-amine; and
2-bromo-N,5-bis(2,4-difluorophenyl)-4-methyl-1H-imidazol-1-amine.

8. A fungicidal composition comprising (a) a compound of claim 1; and (b) at least one other fungicide.

9. A fungicidal composition comprising (a) a compound of claim 1; and (b) at least one additional component selected from the group consisting of surfactants, solid diluents and liquid diluents.

10. A method for controlling plant diseases caused by fungal plant pathogens comprising applying to the plant or portion thereof, or to the plant seed, a fungicidally effective amount of a compound of claim 1.
